(19) United States
(12) Patent Application Publication
(10) Pub. No.: US 2026/0312684 A1
(43) Pub. Date: Oct. 8, 2026

(54) INTRA-SATELLITE OPTICAL NETWORKING (ISON) SYSTEM

(71) Applicant: WildStar, LLC, Arlington, TX (US)

(72) Inventor: GREGORY THANE WYLER, STUART, FL (US)

(73) Assignee: WildStar, LLC, Arlington, TX (US)

(21) Appl. No.: 19/566,905

(22) Filed: Mar. 13, 2026

Related U.S. Application Data
(60) Provisional application No. 63/771,573, filed on Mar. 13, 2025.

(51) Int. Cl. H04B 10/118

(52) U.S. Cl. CPC H04B 10/118

(57) ABSTRACT

The disclosed technology is generally directed to Intra-Satellite Optical Networking (ISON). In one example of the technology, a system for ISON is provided. The system includes a plurality of satellite components, an illuminator device, a conversion device, and a fiber optic cable. The illuminator device generates optical input signals based on desired input signals to operate the plurality of satellite components. The conversion device converts the optical input signals to electrical input signals. The illuminator device transmits the optical input signals to the conversion device by way of the fiber optic cable. The plurality of satellite components receive the electrical input signals and perform corresponding operations based on the electrical input signals.

### CROSS REFERENCE TO RELATED APPLICATIONS

This application claims the benefit of U.S. Provisional Application Ser. No. 63/771,573, filed on Mar. 13, 2025, the disclosure of which is incorporated herein by reference.

### TECHNICAL FIELD

This disclosure is directed to satellite communication, and more particularly, to Intra-Satellite Optical Networking (ISON).

### BACKGROUND

Satellites have become indispensable tools for various applications, including communication, Earth observation, navigation, and scientific research. The satellites revolve around the Earth (or other body) at high speeds to provide coverage. Each satellite transmits a beam that covers a specific coverage area or circular footprint (e.g., on the Earth's surface). The coverage area of the beam may vary depending on several factors, including the satellite's altitude, orbit, and the capabilities of communication systems of a satellite.

Intra-satellite networking may include the architecture and protocols utilized to manage and route power and data within or around various subsystems of a satellite. For example, in some satellite designs, the electronics of the various subsystems of the satellite may be distributed over a large area on and around the satellite. The electronics may be radio frequency sensitive. As such, efficient intra-satellite networking may be important to distribute power among the various subsystems and their associated electronics. Efficient intra-satellite networking may also be important to transmit data to the electronics, receive data from the electronics, and process the data accordingly. For instance, quick data transfers within or around the satellite may be required for processing and transmission of signals. Efficient intra-satellite networking may be required to reduce latency and improve the satellite's ability to manage and distribute data across, within or around a satellite.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to an aspect of the present disclosure, an exemplary embodiment of the present disclosure may provide a system for Intra-Satellite Optical Networking (ISON). The system may comprise a plurality of satellite components, an illuminator device, a conversion device, and a fiber optic cable. The illuminator device may be configured to generate optical input signals based on desired input signals to operate the plurality of satellite components. The conversion device may be configured to convert the optical input signals to electrical input signals. The fiber optic cable may be coupled between the illuminator device and the conversion device. The illuminator device may be further configured to transmit the optical input signals to the conversion device by way of the fiber optic cable. The plurality of satellite components may be coupled to the conversion device, and configured to receive the electrical input signals and perform corresponding operations based on the electrical input signals.

Implementations may include one or more of the following features. In some implementations, the illuminator device may comprise an optical source and a processor. The optical source may be configured to generate the optical input signals. The processor may be coupled to the optical source, and configured to control a set of parameters of the optical input signals generated by the optical source based on the desired input signals. The set of parameters of the optical input signals may comprise at least one of an intensity of the optical input signals, a phase of the optical input signals, and an amplitude of the optical input signals.

In some implementations, the conversion device may comprise a set of photovoltaic (PV) panels and a set of directing elements. The set of PV panels may be configured to convert the optical input signals to the electrical input signals. The set of directing elements may be disposed on the set of PV panels. Each directing element of the set of directing elements may be configured to direct the optical input signals received through the fiber optic cable on a respective PV panel of the set of PV panels.

In some implementations, each directing element of the set of directing elements may comprise a mirror-coated top surface and mirror-coated side surfaces configured to receive the optical input signals and reflect the optical input signals towards the respective PV panel, thereby directing the optical input signals on the respective PV panel.

In some implementations, the system may further comprise a feedback device configured to determine a power output of the electrical input signals and generate a difference signal based on the electrical input signals and the desired input signals. The illuminator device may generate the optical input signals further based on the difference signal.

In some implementations, the feedback device may comprise a power output measuring device, an optical relay, a second conversion device, a second fiber optic cable, and a controller. The power output measuring device may be configured to determine the power output of the electrical input signals. The optical relay may be coupled to the power output measuring device, and configured to convert the power output of the electrical input signals to optical feedback signals. The second conversion device may be configured to receive the optical feedback signals and convert the optical feedback signals to electrical feedback signals. The second fiber optic cable may be coupled between the optical relay and the second conversion device. The optical relay may be further configured to transmit the optical feedback signals to the second conversion device by way of the second fiber optic cable. The controller may be coupled to the second conversion device, and configured to compare the electrical feedback signals with the desired input signals to generate the difference signal and transmit the difference signal as a feedback to the illuminator device.

In some implementations, the feedback device may comprise a discrete circuit and a controller. The discrete circuit may be configured to receive the electrical input signals, generate one of pulse signals and information bits based on the electrical input signals, and transmit one of the pulse signals and the information bits. The controller may be coupled to the discrete circuit, and configured to receive one of the pulse signals and the information bits, convert one of the pulse signals and the information bits to electrical feedback signals, compare a power output of the electrical feedback signals with a power output of the desired input signals to generate the difference signal, and transmit the difference signal as a feedback to the illuminator device.

In some implementations, the feedback device may comprise a power output measuring device, a controller, and a wireless communication device. The power output measuring device may be configured to determine the power output of the electrical input signals. The controller may be configured to receive the power output of the electrical input signal, compare the power output of the electrical input signals with a power output of the desired input signals to generate the difference signal, and transmit the difference signal as feedback to the illuminator device. The wireless communication device may be coupled between the power output measuring device and the controller. The power output measuring device may be further configured to transmit the power output of the electrical input signals to the controller by way of the wireless communication device.

In some implementations, the plurality of the satellite components may comprise payload components, power generation and storage components, power management and distribution components, thermal control components, attitude and orbit control components, command and data handling components, communication components, navigation and control components, telemetry components, sensor components, and structural and mechanical components.

In some implementations, the plurality of the satellite components may comprise a plurality of radiating elements configured to receive the electrical input signals and perform beam forming operations based on the electrical input signals to implement digital beam forming.

In some implementations, the fiber optic cable may be further configured to transmit the optical input signals from the illuminator device to the conversion device utilizing one of a time domain switching technique and a frequency domain switching technique.

In another aspect of the present disclosure, an exemplary embodiment of the present disclosure may provide a system for intra-satellite optical networking (ISON). The system may comprise an element pane comprising a plurality of radiating elements formed on a substrate, a processor, a plurality of illuminator devices, a plurality of fiber optic cables, and a plurality of conversion devices. In one embodiment, the element plane of the satellite may include a surface of the satellite where the radiating elements of the phased array antenna system are formed, printed or otherwise disposed. Each of the plurality of illuminator devices includes: an optical source configured to generate optical input signals based on desired input signals for operating a plurality of radiating elements and a digital signal processor (DSP) configured to perform digital beam forming (DBF) operations by controlling the phase and amplitude of the optical input signals. Each of the plurality of fiber optic cables is configured to transmit the optical input signals from a respective illuminator device. Each of the plurality of conversion devices is configured to receive and convert the optical input signals into electrical input signals. Each of the plurality of radiating elements are coupled to at least one of the plurality of conversion devices. Each of the plurality of conversion devices is configured to transmit the electrical input signals to at least one of the respective radiating elements. The plurality of radiating elements are each configured to receive the electrical input signals from the at least one of the plurality of conversion devices coupled to respective radiating element.

In some implementations, each of the plurality of radiating elements is configured to radiate electromagnetic waves which are steered based on the DBF operations performed by the DSP.

In some implementations, the processor is configured to synchronize the DSPs of the plurality of illuminator devices to perform digital beam forming.

In some implementations, the optical source of each illuminator device is configured to generate optical input signals based on difference signals that indicate variations between the desired input signals and the electrical input signals.

In some implementations, the system further comprises a plurality of feedback devices, each coupled between a respective conversion device and a respective illuminator device. Each of the plurality of feedback devices is configured to determine the power output of the electrical input signals, generate a difference signal based on the electrical input signals and the desired input signals, and transmit the difference signal to the respective illuminator device.

In some implementations, each DSP is configured to dynamically adjust the phase and amplitude of the optical input signals to enable electronic beam steering.

In some implementations, the plurality of radiating elements collectively form a phased array antenna system.

In some implementations, each conversion device is coupled to a single radiating element of the plurality of radiating elements. In some other implementations, each conversion device is coupled to multiple radiating elements of the plurality of radiating elements. In some other implementations, each radiating element is configured to operate in a microwave frequency band.

According to another aspect of the present disclosure, a system for intra-satellite optical networking (ISON) is provided. The system includes an element plane of a satellite including a plurality of radiating elements. The element plane of the satellite may include or be a surface of the satellite where radiating elements of a phased array antenna system are formed, printed or otherwise disposed. The system includes an illuminator device comprising an optical source configured to generate optical input signals based on desired input signals for operating at least one of the plurality of radiating elements, and a digital signal processor (DSP) coupled to the optical source and configured to control at least one parameter of the optical input signals including at least one of an intensity, a phase, and an amplitude of the optical input signals. The system includes a conversion device. The system includes a fiber optic cable coupling the illuminator device to the conversion device. The conversion device comprises a set of photovoltaic (PV) panels configured to convert the optical input signals into electrical input signals, and a set of directing elements disposed on the set of PV panels, each directing element including a mirror-coated top surface and mirror-coated side surfaces configured to receive the optical input signals and reflect the optical input signals toward a respective PV panel of the set of PV panels. The system includes a feedback device coupled between the conversion device and the illuminator device. The feedback device comprises a power output measuring device configured to determine a power output of the electrical input signals, an optical relay coupled to the power output measuring device and configured to convert the power output of the electrical input signals into optical feedback signals, a second fiber optic cable coupled to the optical relay, a second conversion device coupled to the second fiber optic cable and configured to convert the optical feedback signals into electrical feedback signals, and a controller coupled to the second conversion device and configured to compare the electrical feedback signals with the desired input signals to generate a difference signal and transmit the difference signal to the illuminator device. The DSP is configured to control the optical source based on the difference signal such that the electrical input signals are adjusted toward the desired input signals.

Implementations of the system may include one or more of the following features. The system may include one or more of the following features. Each conversion device may be coupled to a single radiating element of the plurality of radiating elements. Each conversion device may be coupled to multiple radiating elements of the plurality of radiating elements. The fiber optic cable may be configured to transmit the optical input signals utilizing a time domain switching technique. The fiber optic cable may be configured to transmit the optical input signals utilizing a frequency domain switching technique. The system may further comprise a processor configured to synchronize a plurality of DSPs of a plurality of illuminator devices to perform digital beam forming. The optical source may be configured to generate the optical input signals based on difference signals indicative of variations between the desired input signals and the electrical input signals. The optical relay may comprise one of a light emitting diode and a laser diode. The optical relay may be configured as one of a digital optical relay and an analog optical relay. The fiber optic cable may comprise a single-mode fiber and the second fiber optic cable may comprise a multimode fiber.

According to yet another aspect of the present disclosure, a system for intra-satellite optical networking (ISON) is provided. The system includes an element plane comprising a substrate and a plurality of radiating elements formed on the substrate. In one embodiment, the element plane of the satellite may include or be a surface of the satellite where radiating elements of a phased array antenna system are formed, printed or otherwise disposed. The system includes a plurality of illuminator devices, each illuminator device comprising an optical source configured to generate optical input signals based on desired input signals for operating at least one radiating element, and a digital signal processor (DSP) coupled to the optical source and configured to control phase and amplitude of the optical input signals to perform digital beam forming (DBF). The system includes a plurality of fiber optic cables, each fiber optic cable coupling a respective illuminator device to a respective conversion device. The system includes a plurality of conversion devices, each conversion device being configured to receive the optical input signals, convert the optical input signals into electrical input signals, and transmit the electrical input signals to at least one radiating element. The system includes a processing system configured to synchronize the DSPs of the plurality of illuminator devices to perform digital beam forming across the plurality of radiating elements.

Implementations of the system may include one or more of the following features. Each conversion device may comprise a set of photovoltaic panels and a set of directing elements disposed on the set of photovoltaic panels. Each conversion device may be coupled to a single radiating element. Each DSP may be configured to dynamically adjust the phase and amplitude of the optical input signals to enable electronic beam steering. The optical source of each illuminator device may be configured to generate the optical input signals based on difference signals indicative of variations between the desired input signals and the electrical input signals. The system may further comprise a plurality of feedback devices, each feedback device being coupled between a respective conversion device and a respective illuminator device and configured to determine a power output of the electrical input signals, generate a difference signal based on the electrical input signals and the desired input signals, and transmit the difference signal to the respective illuminator device. Each radiating element may be configured to operate in a microwave frequency band.

According to yet another aspect of the present disclosure, a conversion device for use in an intra-satellite optical networking system is provided. The conversion device includes a set of photovoltaic (PV) panels configured to convert received optical input signals into electrical input signals. The conversion device includes a set of directing elements disposed on the set of PV panels, each directing element including a mirror-coated top surface and mirror-coated side surfaces configured to receive optical input signals from a fiber optic cable termination and reflect the optical input signals toward a respective region of a PV panel. The conversion device includes an electrical interface configured to provide the electrical input signals to at least one radiating element or satellite component.

Implementations of the system may include one or more of the following features. The conversion device may be disposed on an element plane of a satellite and may be coupled to at least one radiating element. In one embodiment, the element plane of the satellite may include or be a surface of the satellite where radiating elements of a phased array antenna system are formed, printed or otherwise disposed. The conversion device may be configured to provide the electrical input signals to a power output measuring device for closed-loop feedback control. The directing elements may be configured to receive optical input signals from one of a multimode fiber and a single-mode fiber. The conversion device may be configured to convert the optical input signals into electrical input signals providing a nominal voltage in a range of approximately 3.3 volts to 5 volts.

Further aspects, features, applications, and advantages of the disclosed technology, as well as the structure and operation of various examples, are described in detail below with reference to the accompanying drawings. It is noted that the disclosed technology is not limited to the specific examples described herein. Such examples are presented herein for illustrative purposes only. Additional examples will be apparent to persons skilled in the relevant art(s) based on the teachings contained herein.

### BRIEF DESCRIPTION OF THE DRAWINGS

For a better understanding of the present disclosure, non-limiting and non-exhaustive examples of the present disclosure are described with reference to the following drawings, in which:

FIG. 1 is a simplified diagram illustrating a communication system in which aspects of the technology may be employed;

FIG. 2 is a block diagram of an exemplary phased array antenna system in which aspects of the technology may be employed;

FIG. 3A is a block diagram illustrating an ISON system, according to aspects of the disclosed technology;

FIG. 3B is a block diagram illustrating an ISON system, according to another aspect of the disclosed technology;

FIG. 3C is a block diagram illustrating an ISON system, according to yet another aspect of the disclosed technology;

FIG. 4 is a block diagram illustrating an element plane of a satellite, according to aspects of the disclosed technology; and

FIG. 5 is a diagram illustrating one example of a computing device in which aspects of the technology may be practiced.

In the drawings, similar reference numerals refer to similar parts throughout the drawings unless otherwise specified. These drawings are not necessarily drawn to scale.

### DETAILED DESCRIPTION

Technologies are provided for satellite communication, and in particular, for Intra-Satellite Optical Networking (ISON). The specification and accompanying drawings disclose one or more exemplary embodiments that incorporate the features of the present disclosure. The scope of the present disclosure is not limited to the disclosed embodiments. The disclosed embodiments merely exemplify the present disclosure, and modified versions of the disclosed embodiments are also encompassed by the present disclosure. Embodiments of the present disclosure are defined by the claims appended hereto.

It is noted that any section/subsection headings provided herein are not intended to be limiting. Any embodiments described throughout this specification, and disclosed in any section/subsection may be combined with any other embodiments described in the same section/subsection and/or a different section/subsection in any manner.

Implementations of the techniques described herein may include hardware, a method or process, or a non-transitory computer readable medium, etc. Other embodiments of this aspect include corresponding computer systems, apparatus, and computer programs recorded on one or more computer storage devices, each configured to perform the actions of the methods. The system may include one or more computers that can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. Implementations may include one or more of the following features. Prior to describing exemplary embodiments that incorporate the features of the present disclosure, a discussion of technical problems with conventional Intra-Satellite Networking technologies will be provided.

Low earth orbit (LEO) communication satellites are equipped with a base station and revolve around the Earth at high speeds. A LEO communication satellite transmits a beam that covers a specific coverage area or circular footprint (e.g., on the Earth's surface). The coverage area may vary from hundreds to over tens of thousands square kilometers (km²). The coverage area may vary depending on several factors, including the satellite's altitude (e.g., about 180 kilometers to 2,000 kilometers above the Earth's surface), the frequency it operates at, and the antenna design. The number of cells within the coverage area depends on the satellite's design. In a simple scenario, a LEO satellite may have one beam that covers its entire footprint, but in more advanced systems, a single LEO satellite may have multiple spot beams to provide more focused coverage, where each sport beam covers a portion of the satellite's coverage area, which may also be referred to as a cell. The radius of each cell within the satellite's coverage area depends on the satellite's altitude, frequency band, and the antenna design. Depending on the implementation, the cell radius could range from ten or less kilometers to over a hundred kilometers.

A LEO satellite that radiates multiple spot beams typically does so by implementing a phased array antenna system that includes multiple radiating elements. Phased array antenna systems in satellites utilize multiple radiating elements that can be controlled to steer beams electronically without mechanical movement. The operation of such systems involves precise control of the phase and amplitude of signals provided to individual radiating elements. Coordinating the signals across numerous radiating elements while maintaining signal integrity presents ongoing challenges in satellite communication system design.

For instance, because each radiating element has to be provided with power and an RF signal, it typically requires multiple wired connections (e.g., wiring or data cables), which add weight and occupy valuable space within the volume occupied by the satellite. This problem is exacerbated as the number of radiating elements increases. As the number for wired connections increases, the manufacturing complexity and cost also increase.

Conventional intra-satellite networks utilize wiring and/or data cables to connect various subsystems and electronics of the satellite to supply power and enable data transfer. As such, various subsystems and electronics of the satellite rely on wiring and/or data cables that mechanically and electrically connect to a power distribution system, which may be connected to batteries. For instance, satellite communication systems utilize various architectures for distributing signals and power to radiating elements of antenna systems onboard the satellite. In this context, traditional approaches for intra-satellite signal distribution rely on electrical wiring and coaxial cables to transmit signals from processing units to antenna elements (also referred to as radiating elements) of the satellite.

Electrical wiring and cables present several challenges in satellite applications. The wiring or data cables may be heavy and bulky. These systems contribute to the overall mass of the satellite, which affects launch costs and fuel consumption for orbital maneuvers. The routing of numerous electrical cables within the confined area or space of a satellite can also create design constraints and complicate thermal management.

Additionally, electrical conductors of the wiring or data cables may also be susceptible to electromagnetic interference (EMI), which can degrade signal quality and affect the performance of communication systems. To explain further, in conventional intra-satellite network systems, radio frequency (RF) communication and wired connections may be utilized for communication between subsystems within a satellite and for power distribution. RF systems may be susceptible to electromagnetic interference (EMI), which may degrade signal quality. As such, it is desirable to avoid or reduce EMI as much as possible.

Conventional intra-satellite network systems that implement wiring or data cables may also fail to provide high bandwidth and low latency that may be required for modern data-intensive applications. Further, may also only be capable of supporting relatively low bandwidth data transfers. In addition, the data rates that may be achievable over wiring or data cables may be insufficient to support data transfer speeds.

Wired connections (e.g., wiring or data cables) in the conventional systems may be heavy and bulky, and thus, may add weight and occupy valuable space within the satellite. The weight and bulkiness of these wired connections may increase the cost of the satellite. These problems become even more pronounced as the number of connections that are required increases. For instance, this can be particularly problematic in communications satellites that implement a phased array antenna system that includes many radiating elements that each require multiple wired connections. For example, in some phased array antenna systems, the number of radiating elements can be well over 1000, each requiring two or more wired connections for signal and power. That is just for the payload antenna system and does not even consider all of the other components and subsystems that also require wired connections.

Thus, it would be desirable for intra-satellite network systems, to avoid radio frequency (RF) communication connections for communication between subsystems within a satellite and wired connections for power distribution.

In accordance with the disclosed embodiments, a system for the ISON includes a plurality of satellite components, an illuminator device, a conversion device, a fiber optic cable, and a feedback device. The illuminator device may be configured to generate optical input signals based on desired input signals to operate the plurality of satellite components. The fiber optic cable may be coupled between the illuminator device and the conversion device. The illuminator device may be further configured to transmit the optical input signals to the conversion device by the way of the fiber optic cable. The conversion device may be configured to convert the optical input signals to electrical input signals.

The satellite components may be coupled to the conversion device and may be configured to receive the electrical input signals and perform corresponding operations based on the electrical input signals. The feedback device may be configured to determine a power output of the electrical input signals and generate a difference signal based on the electrical input signals and the desired input signals. Further, the illuminator device generates the optical input signals further based on the difference signal.

The fiber optic cable has the lower weight and lower power requirements. The fiber optic cable has higher bandwidth that enables transporting large amount of data at higher rate. The fiber optic cable may transmit data over long distances without significant signal loss and may be less susceptible to EMI. The fiber optic cable may have low latency that may be important for transferring the large amount of data at higher rate.

As used herein, the term “fiber optic cable” may refer to a structure composed of one or more optical fibers enclosed within a protective sheath, designed to transmit light signals for data communication, sensing, or other optical applications. A fiber optic cable may include a core, a cladding, and a coating. The core is central part of the fiber optic cable through which light travels. The core carries the light signals, and the cladding surrounds the core and reflects the light back in the core. In this way, the cladding ensures internal reflection and signal containment that allows for transmission using fiber optic communication. The coating protects the fiber from damage and moisture. Types of the fiber optic cable may include a single mode fiber optic cable and a multimode fiber optic cable.

As used herein, a “fiber optic communication” may refer to the transmission of data, voice, or other signals using light pulses through optical fibers. In fiber optic communication, data may be transmitted by sending pulses through thin strands of a glass or a plastic fiber optic cable. A fiber optic communication system typically includes an optical transmitter, which converts electrical signals into optical signals for transmission through an optical fiber, an optical fiber medium for signal propagation, and an optical receiver, which is a device that detects and converts incoming optical signals into electrical signals for further processing. An optical transmitter typically includes a light source, such as a laser diode or LED, a driver circuit, and a modulation mechanism to encode data into the optical signal, while an optical receiver typically includes a photodetector, such as a photodiode or avalanche photodiode, an amplifier, and a signal processing unit to reconstruct the transmitted information.

Analog fiber optic communication is a form of fiber optic transmission where information is carried as a continuously varying optical signal, typically representing an analog electrical input. Analog fiber optic communication may include transmitting analog signals over the fiber optic cable. The analog fiber optic communication may utilize one of intensity modulation and frequency modulation. Intensity of a light source may be varied in proportion to the analog signal in the intensity modulation. Frequency of a light wave may be varied according to the analog signal in the frequency modulation. In analog fiber optic communication systems, the optical transmitter may convert electrical analog signals into optical signals utilizing the light source such as a light amplification by stimulated emission of radiation (LASER) diode or light emitting diode (LED). The fiber optic cable may transmit the optical signals over long distance with minimal loss. The optical receiver may convert the received optical signals to the electrical analog signals utilizing a photo detector. Analog fiber optic communication systems are commonly used in applications requiring high-fidelity signal transmission.

Digital fiber optic communication refers to the transmission of data using discrete optical pulses that represent binary data (0s and 1s). As such, digital fiber optic communication may include transmitting digital signals (binary data) through a fiber optic cable utilizing light pulses. In a digital fiber optic communication system, the optical transmitter may convert electrical digital signals to optical signals utilizing a LASER diode or LED. The optical signals can be generated using modulation techniques such as on-off keying (OOK), pulse-code modulation (PCM), or wavelength division multiplexing (WDM). The fiber optic cable may transmit the optical signals over long distances with minimal loss. The optical receiver may convert the received optical signals to the electrical digital signals using a photo detector.

Fiber optic technology offers an alternative approach for signal transmission that provides certain advantages over traditional electrical conductors. Fiber optic cables are generally lighter than equivalent electrical cables and exhibit immunity to electromagnetic interference. However, the integration of fiber optic systems within satellites for distributing signals to radiating elements presents its own set of technical considerations, including the conversion of optical signals to electrical signals suitable for driving radiating elements.

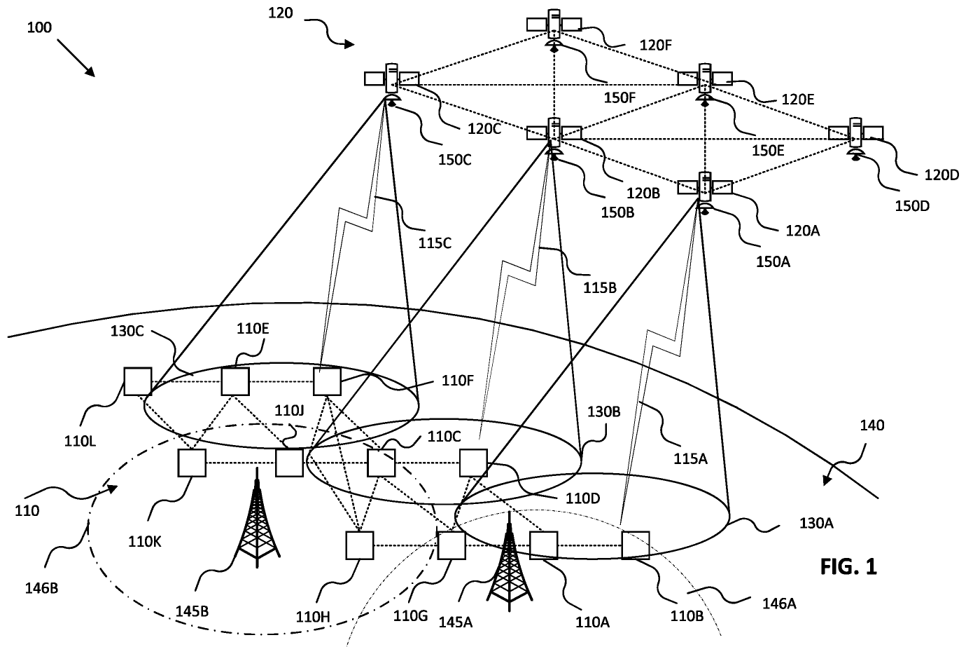

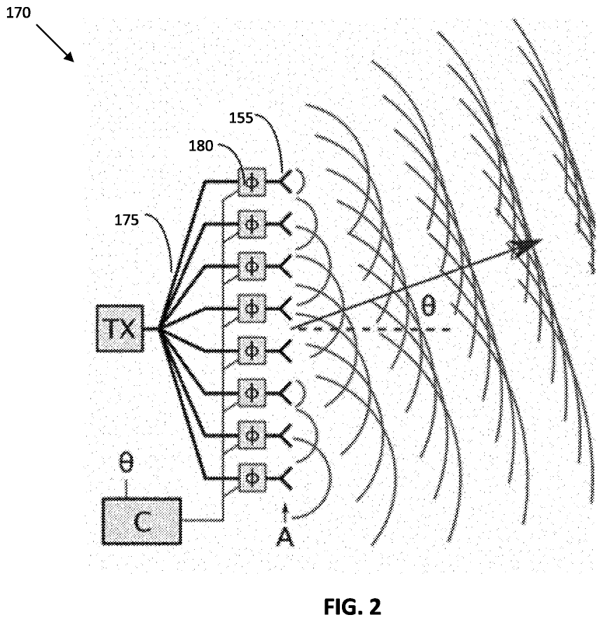

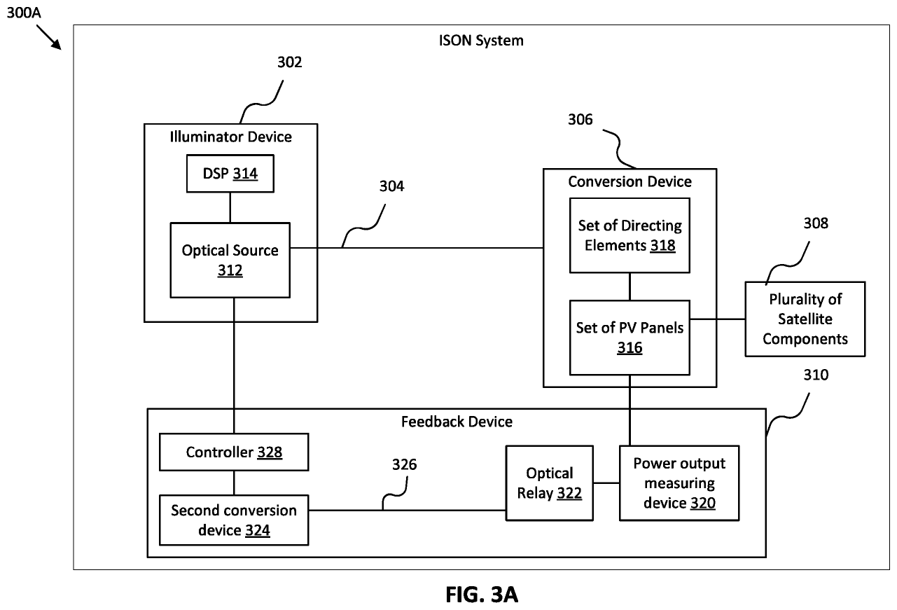

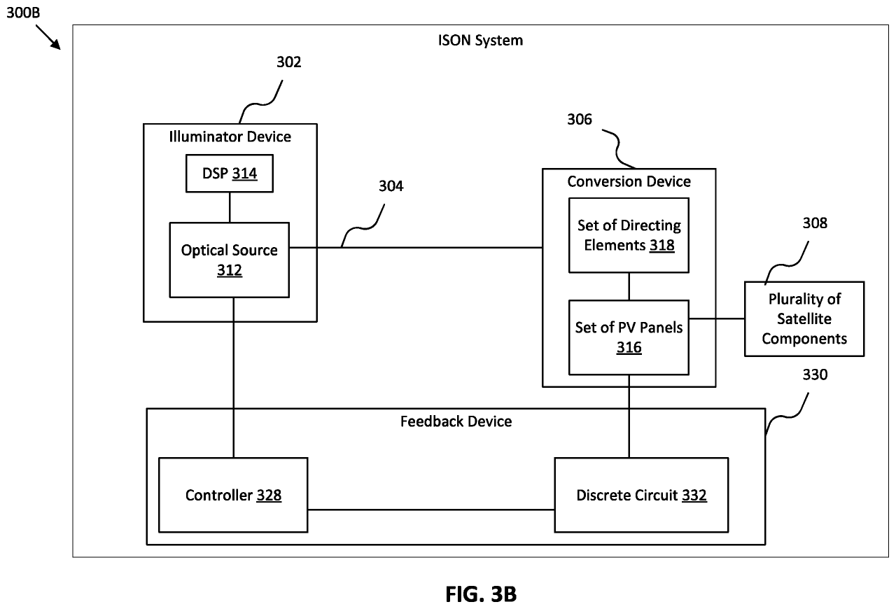

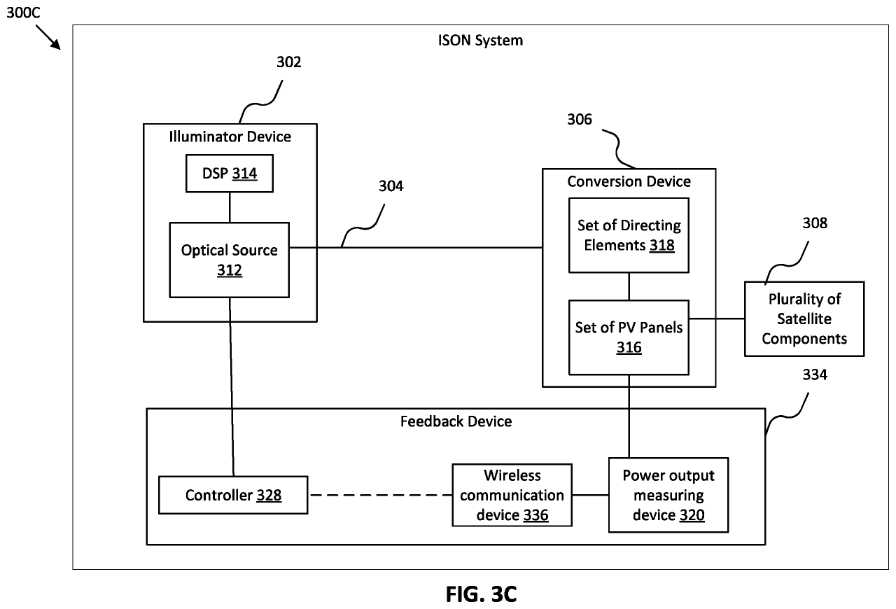

Prior to describing examples of systems for ISON on a satellite that can be applied within the context of the present disclosure with reference to FIGS. 3A-5, an example of a communication system 100 will now be described with reference to FIGS. 1 and 2.

FIG. 1 is a simplified diagram illustrating a communication system 100 in which aspects of the technology may be employed. System 100 includes multiple user equipment (UE) 110 that are in communication with each other, a constellation of satellites 120 that are in communication with one or more of the UE 110, and multiple ground base stations 145 that are in communication with one or more of the UE 110. The constellation of satellites 120 includes a group of artificial satellites that are positioned in a number of different orbits around the Earth 140 to provide specific services or coverage. For instance, the satellites 120 may work together to offer communication, navigation, or remote sensing services to a wide geographic area on Earth. The constellation of satellites 120 may include any number of satellites to ensure global coverage and to provide redundancy in case of failure.

In one embodiment, the satellites 120 may make up a 5G Non-Terrestrial Network, such as a Low Earth Orbit (LEO) constellation, and each satellite 120 includes a base station 150 that acts or serves as a network node of the non-terrestrial network. The ground base stations 145 may make up a Terrestrial Network and each ground base station 145 acts or serves as a network node of the Terrestrial Network. In some cases, the system 100 may support enhanced broadband communications, ultra-reliable (e.g., mission critical) communications, low latency communications, or communications with low-cost and low-complexity devices. It should be appreciated that such satellite constellations may be arranged in different configurations, including low Earth orbit (LEO), medium Earth orbit (MEO), or geostationary orbit (GEO), depending on the intended application and the desired level of coverage and service.

Each of the satellites 120 is an artificial object placed in orbit around a celestial body, often referring to Earth 140. Each satellite typically includes various components such as a communication or scientific payload, power systems (such as solar panels), propulsion for orbit adjustments, and communication equipment to transmit and receive data to and from Earth 140. Each satellite, e.g., the satellite 120A, may include a base station, e.g., the base station 150A, that may wirelessly communicate with UEs 110 via one or more antennas. The base stations 150 of the satellites 120 may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. The base stations 150 of the satellites 120 may be of different types (e.g., macro or small cell base stations). The UEs 110 described herein may be able to communicate with various types of base stations and network equipment including macro eNBs, small cell eNBs, gNBs, relay base stations, and the like.

Each base station, such as the base station 150A of satellite 120A, may be associated with a particular geographic coverage area, for example, geographic coverage area 130A in which communications with various UEs, such as the UEs 110A and 110B is supported. For sake of simplicity, FIG. 1 shows a simplified representation that includes three geographic coverage areas 130, which may be referred to herein as a first geographic coverage area 130A, a second geographic coverage area 130B, and a third geographic coverage area 130C; however, it should be appreciated that each base station 150 includes an associated geographic coverage area. Each base station may provide communication coverage for a respective geographic coverage area via communication links 115, and communication links 115 between a base station 150 of satellite 120 and a UE 110 may utilize one or more carriers. The communication links may include upstream transmissions from the UE 110 to the base station 150 of satellite 120, or downstream transmissions from the base station 150 of satellite 120 to the UE 110. Downstream transmissions may also be called downlink or forward link transmissions while upstream transmissions may also be called uplink or reverse link transmissions.

Although not shown in FIG. 1, each geographic coverage area 130 of a base station 150 may be divided into sectors (not shown) each making up a portion of the geographic coverage area 130, and each sector may be associated with a cell. For example, each base station may provide communication coverage for a macro cell, a small cell, a hot spot, or other types of cells, or various combinations thereof. In some examples, the base stations may be non-stationary and therefore provide communication coverage for a moving geographic coverage area 130. In some examples, different geographic coverage areas 130 associated with different technologies may overlap, and the overlapping geographic coverage areas 130 associated with different technologies may be supported by the same base station or by different base stations. The system 100 may include, for example, a heterogeneous 5G network in which different types of base stations provide coverage for various geographic coverage areas 130.

The term “cell” refers to a logical communication entity used for communication with a base station (e.g., over a carrier) or a satellite beam, and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 130 (e.g., a sector) over which the logical entity operates.

Each of the ground base stations 145 may wirelessly communicate with UEs 110 via one or more antennas. The ground base stations 145 may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. The ground base stations 145 may be of different types (e.g., macro or small cell base stations). The UEs 110 described herein may be able to communicate with various types of ground base stations and network equipment including macro eNBs, small cell eNBs, gNBs, relay base stations, and the like.

Each ground base station, such as the ground base station 145A, may be associated with a particular coverage area, for example, coverage area 146A in which communications with various UEs, such as the UEs 110A, 110B, and 110G is supported. For sake of simplicity, FIG. 1 shows a simplified representation that includes two coverage areas 146, which may be referred to herein as a first coverage area 146A and a second coverage area 146B; however, it should be appreciated that each ground base station 145 includes an associated coverage area. Each ground base station may provide communication coverage for a respective coverage area.

The UEs 110 may be deployed at different locations in a geographic coverage area 130 or coverage area 146 that includes, for example, a forest, an agricultural land, or the like. In one embodiment, for example, the UEs 110 are positioned at the different locations in certain geographic area to provide sensor coverage over part of or substantially all of the area. The UEs 110 may also be referred to as a mobile device, a wireless device, a remote device, a handheld device, or a subscriber device, or some other suitable terminology, where the “device” may also be referred to as a unit, a station, a terminal, or a client. The UE 110 may also be a personal electronic device such as a cellular phone, a personal digital assistant (PDA), a tablet computer, a laptop computer, or a personal computer. In some examples, the UE 110 may also refer to a wireless local loop (WLL) station, an Internet of Things (IoT) device, an Internet of Everything (IoE) device, or an MTC device, or the like, which may be implemented in various articles such as appliances, vehicles, meters, or the like.

In an embodiment, some or all of the UEs 110 may be implemented as MTC or IoT devices, which may be low cost or low complexity devices, and may provide for automated communication between machines (e.g., via Machine-to-Machine (M2M) communication). M2M communication or MTC may refer to data communication technologies that allow devices to communicate with one another or a base station of a satellite without human intervention. In some examples, M2M communication or MTC may include communications from devices that integrate sensors or meters to measure or capture information and relay that information to a central server or application program that can make use of the information or present the information to humans interacting with the program or application. The UEs 110 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The UEs 110 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for the UEs 110 include entering a power saving “deep sleep” mode when not engaging in active communications, or operating over a limited bandwidth (e.g., according to narrowband communications). In some cases, the UEs 110 may be designed to support critical functions (e.g., mission critical functions), and the system 100 may be configured to provide ultra-reliable communications for these functions.

In some embodiments, a UE, such as the UE 110A may also be able to communicate directly with other UEs, such as the UE 110B (e.g., using a peer-to-peer (P2P) or device-to-device (D2D) protocol). One or more of a group of UEs 110 utilizing D2D communications may be within the geographic coverage area 130 of a base station, such as the geographic coverage area 130A of base station 150 of satellite 120A. Other UEs 110 in such a group may be outside the geographic coverage area 130A of the base station 150 of satellite 120A or be otherwise unable to receive transmissions from the base station 150 of satellite 120A. In some cases, groups of UEs 110 communicating via D2D communications may utilize a one-to-many (1:M) system in which each UE 110 transmits to every other UE 110 in the group. In some cases, a base station facilitates the scheduling of resources for D2D communications. In other cases, D2D communications are carried out between UEs 110 without the involvement of a base station.

In some embodiments, the UEs 110 and the satellites 120 that make up the constellation are designed so that they are capable of non-line-of-sight (NLOS) communications with one another. When communication devices, such as the UEs 110 and based stations implemented at satellites 120, are capable of NLOS communication, the device can establish communication links 115 even when there are obstacles or obstructions between the transmitter and the receiver. In traditional line-of-sight communication, a clear and unobstructed path is needed between the transmitting and receiving antennas for reliable signal transmission. By contrast, NLOS communication allows signals to propagate and reach the receiver even if there are buildings, trees, terrain features, or other obstacles in the way. NLOS communication is particularly important, for example, in urban environments, dense foliage, indoor settings, and situations where direct line-of-sight paths are blocked.

The system 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 110 located indoors or under some obstruction or blockage. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

The system 100 may further operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that can tolerate interference from other users.

The system 100 may further operate in an extremely high frequency (EHF) region of the spectrum (e.g., from 30 GHz to 300 GHz), also known as the millimeter band. In some examples, the system 100 may support millimeter wave (mmW) communications between UEs 110 and base stations of satellites 120, and EHF antennas of the respective devices may be even smaller and more closely spaced than UHF antennas. In some cases, this may facilitate use of antenna arrays within a UE 110. However, the propagation of EHF transmissions may be subject to even greater atmospheric attenuation and shorter range than SHF or UHF transmissions. Techniques disclosed may be employed across transmissions that use one or more different frequency regions, and designated use of bands across these frequency regions may differ by country or regulating body.

In some cases, the system 100 may utilize both licensed and unlicensed radio frequency spectrum bands. For example, the system 100 may employ License Assisted Access (LAA), LTE-Unlicensed (LTE-U) radio access technology, or NR technology in an unlicensed band such as the 5 GHz ISM band. When operating in unlicensed radio frequency spectrum bands, wireless devices such as base stations 150 of satellites 120 and UEs 110 may employ listen-before-talk (LBT) procedures to ensure a frequency channel is clear before transmitting data. In some cases, operations in unlicensed bands may be based on a CA configuration in conjunction with CCs operating in a licensed band (e.g., LAA). Operations in unlicensed spectrum may include downstream transmissions, upstream transmissions, peer-to-peer transmissions, or a combination of these. Duplexing in unlicensed spectrum may be based on frequency division duplexing (FDD), time division duplexing (TDD), or a combination of both.

In some examples, the base stations 150 and/or UEs 110 may be equipped with multiple antennas, which may be used to employ techniques such as transmit diversity, receive diversity, multiple-input multiple-output (MIMO) communications, or beamforming. For example, the system 100 may utilize a transmission scheme between a transmitting device (e.g., a base station 150 or a UE 110) and a receiving device (e.g., a UE 110 or a base station 150), where the transmitting device is equipped with multiple antennas and the receiving devices are equipped with one or more antennas. MIMO communications may employ multipath signal propagation to increase the spectral efficiency by transmitting or receiving multiple signals via different spatial layers, which may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams. Different spatial layers may be associated with different antenna ports used for channel measurement and reporting. MIMO techniques include single-user MIMO (SU-MIMO) where multiple spatial layers are transmitted to the same receiving device, and multiple-user MIMO (MU-MIMO) where multiple spatial layers are transmitted to multiple devices.

### Satellites

Each of the satellites 120 may be a communications satellite that includes at least one base station 150. The base station 150 on the satellite 120 is an important component of the satellite communication systems, serving as an access point for two-way data transmission between Earth-based UEs 110 and the satellites 120 as well as between two or more of the satellites 120. The base station 150 may be housed within (or as part of) the satellite's payload and may include transceivers and antennas designed to facilitate seamless communication across vast distances. The base station 150 plays a role in relaying, amplifying, and routing signals between terrestrial devices, such as the UEs 110, and the satellites 120, ensuring robust and efficient data transfer. The base stations 150 are often equipped with advanced signal processing capabilities, enabling functions like modulation, demodulation, encoding, and decoding to optimize the quality and reliability of communication links 115, and can be important for various satellite-based services, including global broadband internet, broadcasting, navigation, internet of things (IoT) services, and Earth observation.

In one implementation, each satellite 120 may be a 5G Non-Terrestrial Network (NTN) satellite, in which case the base station 150 may be referred to as a “gNodeB.” In this context, a gNodeB may refer to a Third Generation Partnership Project (3GPP)-compliant implementation of the 5G base station. The gNodeB includes independent network functions, which implement 3GPP-compliant new radio (NR) radio access network (RAN) protocols namely.

As described above, each base station 150 may include an antenna system that is capable of communicating with UEs 110. In some embodiments, each antenna system may be implemented as an array antenna system. Antenna arrays, including phased array antenna systems, can dynamically adjust their radiation patterns to focus energy in a desired direction, enhancing the chances of non-line-of-sight (NLOS) communication. Phased array antenna systems are known for their adaptability, as they can dynamically adjust their beam patterns without mechanical movement. This flexibility is especially valuable for satellites in NTN configurations, where efficient communication with multiple ground-based stations and user equipment may be important as the satellite orbits the Earth. Additionally, lower-frequency signals tend to diffract and penetrate obstacles more effectively than higher-frequency signals. Further, when the wavelength of the signal is comparable to the size of the obstacle signals can bend or diffract around obstacles.

In some embodiments, each antenna system may be implemented as a phased array antenna system. One non-limiting example of a phased array antenna system will now be described with reference to FIG. 2, which is a block diagram of an exemplary phased array antenna system in which aspects of the technology may be employed. The phased array antenna system 170 may also be referred to as electronically steerable or scanned array, which may be used in any of the embodiments disclosed herein.

A phased array refers to an array of radiators forming a main beam, wherein the direction of the main beam is electronically steerable by changing the phase/time delay of the RF energy arriving at each of the radiators. For simplicity, the illustration shows a linear array, but for the disclosed embodiments it is more beneficial to utilize a two-dimensional array, such that the beam can be steered in two dimensions. The array comprises radiating elements 185, each connected to a phase shifter 180. Each of the phase shifters 180 may be in the form of a delay line. The phase shifters 180 are controlled by a computer C to introduce a certain amount of delay in the corresponding transmission lines and thereby steer the beam from boresight by an angle θ.

The transmitter TX generates the signal, which is applied to a feed, which splits the signal to be delivered to each of the radiating elements 185. Prior to reaching the radiating element, the signal from the feed passes through the corresponding phase shifter 180 such that the phase of the signal in each delay line is changed by an individual amount to cause the beam to steer. The phase shifters 180 can also be controlled by an on-chip processor or baseband processor. The range of each phase shifter can be quantized into a look-up table (LUT). The beam can be steered by quickly retrieving a phase value from the memory. The reverse happens for reception.

The example illustrated in FIG. 2 is a passive phased array or passive electronically scanned array (PESA), which is a phased array in which the antenna elements are connected to a single transmitter and/or receiver. However, the disclosed embodiments are not limited to PESA, but rather encompass any electronically steerable antenna. For example, an active phased array or active electronically scanned array (AESA) may also be used. AESA is a phased array in which each antenna element has an analog transmitter/receiver (T/R) module which creates the phase shifting to electronically steer the antenna beam. Any of the disclosed embodiments may also be implemented using a digital beam forming (DBF) phased array, which has a digital receiver/exciter at each element in the array. The signal at each element is digitized by the receiver/exciter, so that antenna beams can be formed digitally in a field programmable gate array (FPGA) or the array computer. This approach allows for multiple simultaneous antenna beams to be formed, e.g., by grouping the radiating elements into sub-groups.

In general, it should be appreciated that each antenna may be any electronically steerable antenna having plurality of radiators, such as the phased array antenna similar to the example illustrated in FIG. 2. For simplicity, the disclosure provided herein uses the term “phased array antenna”, but it should be appreciated that the term encompasses any electronically steerable antenna having plurality of radiators forming a radiation pattern the direction of which can be steered electronically.

Referring again to FIG. 1, when the antenna system of each base station 150 is implemented as a phased array antenna system, each phased array antenna system may dynamically steer beams and provide coverage to different locations as the satellite 120 moves across the sky. Stated differently, each phased array antenna system can dynamically steer and shape the radiation pattern of the antenna, making it an important component for establishing efficient and reliable communication links between satellites 120 and ground-based stations and user devices, such as the UEs 110.

Each phased array antenna system may be capable of both transmitting and receiving signals, and may be designed to provide directional control over the transmitted and received electromagnetic signals. For example, when transmitting, each phased array antenna system may be configured to generate a beam of radio waves. In this context, a beam refers to a focused or directed signal that is transmitted from the satellite's antenna to a specific area on the Earth's surface. The satellite's antenna system is designed to concentrate the signal's energy into a narrow region, effectively creating a “beam” of communication that covers a targeted geographic area. In other words, a beam may refer to the directed path of radio waves that target specific areas on the Earth's surface to provide communication services, where a radio wave can refer to a specific type of electromagnetic wave that carries a communication signal with a particular frequency and wavelength. The radio wave includes both the carrier frequency and the modulated information, such as voice, data, or video.

Each phased array antenna system adjusts the phase and amplitude of individual antenna elements to create a focused and directed beam of electromagnetic waves. By carefully controlling the phase relationships of the signals emitted from each element, the antenna can steer the beam's direction without physically moving the entire antenna structure. This directed beam allows the satellite to target specific areas on the Earth's surface for communication.

By contrast, when the phased array antenna system is in receiving mode, it utilizes the same principles of phase and amplitude control to selectively receive signals from a particular direction. The received signals are then combined coherently to enhance the sensitivity of the antenna in that specific direction. This directional receiving capability is useful for efficiently capturing signals from the desired sources while reducing or minimizing interference from other directions.

Each base station 150 may be configured to transmit information to one or more UEs 110 and receive signals from at least one of the UEs 110 processible by the base station (e.g., the network node) of the satellite 120 to establish a connection between the UE 110 and the satellite 120. In an exemplary embodiment of the present disclosure, each antenna of each of the UEs 110 is configured to communicate directly with at least one phased array antenna system of at least one of the plurality of satellites 120.

In an exemplary embodiment of the present disclosure, as illustrated in FIG. 1, the UEs 110 are configured to communicate with each other and exchange data when in range of each other. This allows for the UEs 110 to be configured as a mesh network so that the UEs 110 can communicate information with each other. Similarly, as illustrated in FIG. 1, the satellites 120 are configured to communicate with each other and exchange data when in range of each other. This allows for the satellites 120 to be configured as a mesh network so that the satellites 110 can communicate information with each other via intersatellite links.

### Non-Limiting Example of Satellite

As described above, the antenna system of a satellite may include an antenna array comprising any number of radiating elements collectively configured as part of phased array antenna system that is capable of both transmitting and receiving signals. The radiating elements of a phased array antenna system may be formed, printed or otherwise disposed on or in an element plane of the satellite (e.g., a surface of the satellite). For instance, in one embodiment, the radiating elements may be printed on an ultra-thin polymer film (also referred to as a substrate or antenna element plane herein) using thin-film technology such as that described in U.S. patent application Ser. No. 18/715,030, filed on May 30, 2024. In one implementation, the polymer film may include a layer of polyimide material. This thin film design of the phased array antenna system is designed for high-speed, low-cost manufacturing to provide a very high performance, ultra-thin and low mass phased array antenna system. For example, in one non-limiting embodiment, the total antenna mass is under 5 kilograms. This may reduce launch costs and deliver more satellites per rocket (e.g., hundreds or more satellites may be deployed from a single rocket).

Low frequency phased array antenna systems, such as those designed to operate in the VHF range, have relatively long wavelengths and thus require very large antenna systems. For instance, in one particular non-limiting example, the dimensions of the satellite and its phased array antenna system are large (e.g., 12.5 meters×12.5 meters or e.g., 156.25 square meters in size).

Depending on the implementation, the phased array antenna system may include any number of radiating elements, but it should be appreciated that as the number of radiating elements in the phased array antenna system increases it has ability to generate more precise beams and thus becomes more agile. For example, in one non-limiting example, the antenna array of the satellite may include an x by y grid of radiating elements (e.g., a 24×26 grid of 624 radiating elements). The radiating elements may be configured collectively as part of a phased array antenna system designed to operate at low frequencies, for example, in the VHF range. In the phased array antenna system, the radiating elements may be designed to radiate at a frequency equal to half (½) of a desired wavelength. For example, when a wavelength of 1 meter is desired, then the radiating elements would be 50 centimeters. In one non-limiting embodiment, the radiating elements of the phased array antenna system can be tuned to operate at frequencies as low as 30 MHz.

The radiating elements of the antenna array of the satellite may be designed to operate in conjunction with a high-performance processing system (e.g., with 500 GFlops of central processing power) and one or more separate Digital Signal Processor(s) (DSP(s)) that may be located at or near the center of the satellite. The one or more DSP(s) communicate with the high-speed central processing unit, which will run the Radio Access Network (RAN), Core Network (CN) and Synthetic Aperture Radar (SAR) software for object detection processing. In addition, the high-performance processing system and DSP(s) may work in conjunction with the antenna array to enable agile Digital Beam Forming (DBF) in the VHF range for nulling, beam hopping, beam shaping and interference management.

As noted above, in this particular non-limiting example, the dimensions of the satellite and its phased array antenna system are relatively large. Given the size of the satellite, the radiating elements are distributed over a large surface area. As such, the data transfer between the DSP(s) and the radiating elements may span distances over 5 to 10 meters in some implementations.

Whether for communications, or Synthetic Aperture Radar (SAR), agile DBF may require terabytes per second (Tbps) of data to be moved between radiating elements and the DSP(s) that are used to implement beam forming. For instance, in the example described above, the antenna may have 624 elements and each element will need approximately 4 Gbps of total data traffic to the DSP (in the center of the satellite) with a cumulative speed exceeding 2 Tbps. To explain further, DBF requires high data rates (Tbps data transport) across the satellite while maintaining nanosecond timing. In terms of data requirements, each transmit and receive link of a digitized radio frequency chain is 1.8 Gbps, with 624 simultaneous streams in each direction, totaling 1.1 Tbps of capacity in each direction for a total of 2.2 Tbps of onboard digitized beams traveling across this large antenna (e.g., 156.25 square meters).

One approach for communicatively and physically connecting the DSP(s) to the radiating elements is to utilize wiring or data cables. However, wiring or data cables are relatively bulky, heavy and stiff and, in some cases, may generate RF noise that may impact the radiating elements. The weight of the wiring or data cables may also increase launch costs. The stiffness of the wiring or data cables may also make management and routing difficult due to their stiffness, especially with respect to an antenna of this size that is folded and stowed prior to deployment. Depending on the satellite design, the wiring or data cables may require very specific laydown and routing (e.g., within 1 mm of tolerance across this very large area) in order to ensure timing, repeatability and folding. Additionally, the wiring or data cables are also subject to extreme and high-rate temperature variations which may be problematic because the wiring or data cables are made from metallic conductors. In addition, the data rates that are achievable over wiring or data cables may be insufficient to support data transfer speeds such as those describe above. Another issue is that because the wiring or data cables are conductors, they may radiate large amounts of RF energy when transporting signals and this may introduce noise into the system.

Given the significant distance between the radiating elements and the DSP along with the high data rates that are required therebetween, there is a need for new solutions for intra-satellite communication technologies that may allow for high data rate (HDR) transport between the radiating elements and the DSP.

### Intra-Satellite Optical Networking (ISON)

In accordance with some of the disclosed embodiments, to address this need, an Intra-Satellite Optical Networking (ISON) system is provided that may be used in conjunction with satellites having an antenna system that implements low frequency DBF, such as that described above. The ISON system implements fiber optic communication links between each of the radiating elements and the DSP(s) to allow for high data rate (HDR) transport. Fiber optic communication links have the benefit of ultra-low mass and ultra-low power requirements to transport large amounts of data at a high rate without radiating RF noise. The fiber optic communication links may help maintain signal integrity over the relatively large distances between each of the radiating elements and the DSPs, which are implemented at the satellite's bus, for example. The disclosed ISON system may move data from radiating elements at a high-speed over long distances to DSPs that are used to implement digital beam forming. This may allow the ISON system to transport digital signals around a satellite with a large surface area at a high data rate while maintaining required signal integrity and timing needed to implement low frequency beam agility.

For example, in the context of the exemplary satellite with the ISON system that is described below with reference to FIG. 3A-3C, the disclosed (ISON) system may move high-speed data from the radiating elements over 10 meters (or greater) distances to the centralized DSPs that are used to implement digital beam forming. In one non-limiting implementation, this may allow the ISON system to transport over 4 Tbps of digital signal around the 156 square meter satellite.

The disclosed system may provide low frequency large scale arrays in space that include the ability to communicate NLoS with small devices on a global basis. In one embodiment the disclosed system may allow for the movement of data at the high data rates across the array.

FIG. 3A is a block diagram illustrating the ISON system 300A, according to aspects of the disclosed technology. The ISON system 300A includes an illuminator device 302, a fiber optic cable 304, a conversion device 306, a plurality of satellite components 308, and a feedback device 310. The illuminator device 302 may be configured to generate optical input signals based on desired input signals to operate the plurality of satellite components 308. The illuminator device 302 may be coupled to the optical fiber cable 304, and further configured to transmit the optical input signals to the conversion device 306 by way of the fiber optic cable 304.

In one embodiment, the illuminator device 302 may include an optical source 312 and a processor 314. The optical source 312 may be configured to generate the optical input signals. The optical input signals generated by the optical source 312 may be in one of a visible spectrum and other parts of an electromagnetic spectrum, such as infrared or ultraviolet. The basic working principle of the optical source 312 includes excitation of the active medium by an energy source that causes the electrons in the active medium to move to higher energy levels. The electrons release energy in the form of photons (optical input signals) when the electrons return to their original energy levels. Examples of the optical source 312 may include, but are not limited to, light emitting diodes (LEDs) such as a semiconductor LED and a light amplification by stimulated emission of radiation (LASER) such as a semiconductor LASER.

The processor 314 may be a digital signal processor (DSP) and hereinafter interchangeably referred to as the DSP 314. The DSP 314 may include suitable logic, circuitry, interfaces, and/or code, executable by the circuitry, that may be configured to control a set of parameters of the optical input signals. The set of parameters of the optical input signals may include at least one of an intensity of the optical input signals, a phase of the optical input signals, and an amplitude of the optical input signals. In an embodiment, the DSP 314 may be coupled to the optical source 312, and may be configured to control at least one of the intensity, the phase, and the amplitude of the optical input signals generated by the optical source 312 based on desired input signals. The desired input signals may correspond to signals which when provided to the plurality of satellite components 308, the plurality of satellite components 308 may operate in a desired manner to perform tasks related to satellite communication. In one embodiment, the DSP 314 may be configured to store the desired input signals for the plurality of satellite components 308. In another embodiment, the DSP 314 may be configured to receive an indication signal indicating the desired input signal for the plurality of satellite components 308. The DSP 314 may be an application-specific integrated circuit (ASIC) processor, a reduced instruction set computing (RISC) processor, a complex instruction set computing (CISC) processor, and a field-programmable gate array (FPGA).

The fiber optic cable 304 may be coupled between the illuminator device 302 and the conversion device 306. The fiber optic cable 304 may be further configured to transmit the optical input signals from the illuminator device 302 to the conversion device 306 utilizing one of a time domain switching technique and a frequency domain switching technique. In time domain switching technique, the optical input signals may be allocated specific time slots and the fiber optic cable 304 may transmit the optical input signals sequentially in allocated time slots. In frequency domain switching technique, the optical input signals may be allocated different frequency bands and the fiber optic cable 304 may transmit data and the optical input signals simultaneously but at different frequencies.

The conversion device 306 may be coupled to the optical fiber cable 304, and configured to receive the optical input signals and convert the optical input signals to electrical input signals. In an embodiment, the electrical input signals are similar to the desired input signals. The conversion device 306 may be configured to transmit the electrical input signals to the plurality of satellite components 308 to operate the plurality of satellite components 308. It will be apparent to a person skilled in the art that although in the current embodiment, the conversion device 306 may be configured to transmit the electrical input signals to the plurality of satellite components 308, in various other embodiments, the conversion device 306 may be configured to transmit the electrical input signals to a single satellite component, without deviating from the scope of the present disclosure.

In one embodiment, the conversion device 306 may include a set of photovoltaic (PV) panels 316 and a set of directing elements 318. Photovoltaic cells, also referred to as “solar cells,” are well known devices that convert light energy directly into electrical energy based on a photovoltaic effect. Photovoltaic cells may be packaged together in a PV panel, which comprises a plurality of interconnected photovoltaic cells. Each PV panel may be configured to receive the optical input signals directed by the respective directing element. The set of PV panels 316 may be configured to convert the received optical input signals to the electrical input signals based on the photovoltaic effect.

The set of directing elements 318 may be disposed on the set of PV panels 316. Each directing element may be configured to direct the optical input signals received through the fiber optic cable 304 on respective PV panel. Each directing element includes a mirror-coated top surface and mirror-coated side surfaces that may be configured to receive the optical input signals and reflect the optical input signals towards the respective PV panel, thereby directing the optical input signals on the respective PV panel.

The plurality of satellite components 308 may be coupled to the conversion device 306 and may be configured to receive the electrical input signals from the conversion device 306. In one embodiment, the plurality of satellite components 308 may be coupled to the set of PV panels 316 to receive the electrical input signals. The plurality of satellite components 308 may be further configured to perform corresponding operations (the desired operations) based on the electrical input signals. In one embodiment, the plurality of satellite components 308 may include payload components, power generation and storage components, power management and distribution components, thermal control components, attitude and orbit control components, command and data handling components, communication components, navigation and control components, telemetry components, sensor components, and structural and mechanical components.

The payload components may include transponders and an antenna feed system. The transponders may be configured to receive the signals from the ground, amplify the received signals, and retransmit the amplified signals to the ground. The antenna feed system may include a horn antenna, parabolic reflectors, and waveguides. The horn antenna may be configured to collect or radiate electromagnetic waves. The waveguides may be configured to at least one of guide the electromagnetic waves from the horn antenna to the transponders and guide the electromagnetic waves from the transponders to the horn antenna. The power generation and storage components may include solar panels to convert sunlight to electrical power and batteries to store the electrical energy and utilized the stored electrical energy when the satellite is in the shadow of the Earth or during peak power demands.

The power management and distribution components may include a power regulation and conditioning device, battery charge regulators, and distribution switching devices. The power regulation and conditioning device may be configured to regulate the voltage and current to enable consistent and reliable power supply to the remaining plurality of satellite components 308. The battery charge regulators may be configured to control the charging and discharging of the onboard batteries. The distribution switching devices may be configured to manage the distribution of power to different satellite subsystems.

The thermal control components may include heaters, thermal radiators, and thermal blankets. The heaters may be configured to maintain the temperature of important components of the plurality of satellite components 308 within the operational range of the plurality of satellite components 308. The thermal radiators may be configured to dissipate excess heat from the satellite. The thermal blankets may be configured to insulate and protect sensitive components of the plurality of satellite components 308 from extreme temperatures.

The attitude and orbit control components may include reaction wheels, magnetorquers, and a propulsion system. The reaction wheels may be configured to control the orientation of the satellite and maintain stability. The magnetorquers may be configured to utilize magnetic fields, thereby controlling the orientation of the satellite. The propulsion system may include thrusters that may be configured to adjust one of orbit of satellite and attitude of satellite. The command and data handling components may include onboard computers, data handling devices, and solid-state data recorders. The onboard components may be configured to control and manage all operations and processes of the satellite. The data handling devices may be configured to process and store the data received from the payload components. The solid-state data recorders may be configured to store mission data for later transmission to the ground.

The communication components may include transceivers and antennas. The transceivers may be configured to utilize for telemetry, tracking, and command (TT&C) and payload data transmission. The antennas may include high-gain antennas that may be configured to communicate with ground stations and low-gain antennas that may be configured to control the satellite and monitor the satellite. The navigation and control components may include global positioning systems (GPS) receivers and inertial measurement units (IMUs). The GPS receivers may be configured to determine a position and velocity of the satellite. The IMUs may be configured to provide precise attitude and orientation data.

The telemetry components may include TT&C transmitters and receivers and command decoders and encoders. The TT&C transmitters and receivers may be configured to communicate with ground control stations. The command decoders and encoders may be configured to decode commands from the ground and encode responses from the satellite. The sensor components may include Sun sensors, star trackers, and momentum wheel tachometers. The Sun sensors may be configured to detect a position of the Sun for orientation and power generation. The star trackers may be configured to determine orientation of the satellite by identifying stars. The momentum wheel tachometers may be configured to measure rotation speed of the reaction wheels.

The structural and mechanical components may include support structures and deployable mechanisms. The support structures may be a framework that holds the plurality of satellite components 308 together. The deployable mechanisms may be systems for deploying the solar panels, the antennas, and other equipment after launching the satellite. The microwave switches and filters may be utilized in the radio frequency (RF) chain to direct and filter signals. The waveguides switches and filters may be configured to direct and filter high-frequency signals within the satellite.

Each component and devices of the plurality of satellite components 308 may be important for the proper functioning of a communications satellite, and the plurality of satellite components 308 may collectively consume the electrical input signals to operate. The power consumption of each component may vary depending on design of the satellite, mission requirements, and operational mode.

For example, the navigation and control components that include the GPS receiver may operate at the desired input signals that may be a voltage between 3.3 volt to 5 volt. The illuminator device 302 may be configured to generate optical input signals based on the desired input signals of the GPS receiver, e.g., 3.3 volt required to operate the GPS receiver. The illuminator device 302 may be further configured to transmit the generated optical input signals to the conversion device 306 by the way of the fiber optic cable 304. The conversion device 306 may be configured to convert the optical input signals to the electrical optical signals. The conversion device 306 may be further configured to transmit the electrical input signals, e.g., approximately 3.3 volt to the GPS receiver to perform corresponding operations.

In another embodiment, the plurality of the satellite components may include a plurality of radiating elements that may be configured to receive the electrical input signals. Each of the plurality of radiating elements may be configured to radiate electromagnetic waves which are steered based on the DBF operations. The plurality of radiating elements may be further configured to perform beam forming operations based on the electrical input signals to implement digital beam forming.

The feedback device 310 may include suitable logic, circuitry, interfaces, and/or code, executable by the circuitry, that may be configured to receive the electrical input signals from the conversion device 306. The feedback device 310 may be configured to determine a power output of the electrical input signals and generate the difference signal based on the electrical input signals and the desired input signals. The DSP 314 may be configured to receive the difference signal from the feedback device 310. The DSP 314 may be further configured to control the intensity of the optical input signals based on the difference signal.

In an embodiment, the feedback device 310 may include a power output measuring device 320, an optical relay 322, a second conversion device 324, a second fiber optic cable 326, and a controller 328. The power output measuring device 320 may be configured to receive the electrical input signals from the set of PV panels 316 and determine the power output of the received electrical input signals. In one embodiment, the power output measuring device 320 may be configured to determine the power output of the received electrical input signal in watts.

The optical relay 322 may be coupled to the power output measuring device 320. The optical relay 322 may be configured to convert the power output of the electrical input signals to the optical feedback signals. The optical relay 322 may be further configured to transmit the optical feedback signals to the second conversion device 324 by way of the second fiber optic cable 326. In an embodiment, the optical relay 322 may be a digital optical relay. In another embodiment, the optical relay 322 may be an analog optical relay which may be utilized to convert the power output of the electrical input signals to the optical feedback signals. The optical relay 322 may include one of the LED and laser diode that may be configured to convert the power output of the electrical input signals to the optical feedback signals.

The second conversion device 324 may include suitable logic, circuitry, interfaces, and/or code, executable by the circuitry, that may be configured to receive the optical feedback signals and convert the optical feedback signals to electrical feedback signals. The second conversion device 324 may include a photo detector (not shown) that may be configured to convert the optical feedback signals to the electrical feedback signals. The second conversion device 324 may be further configured to transmit the electrical feedback signals to the controller 328.

The second fiber optic cable 326 may be coupled between the optical relay 322 and the second conversion device 324. In one embodiment, the fiber optic cable 304 may correspond to a single mode fiber cable and the second fiber optic cable 326 may correspond to a multimode fiber cable. In an embodiment, the fiber optic cable 304 may transmit the optical input signals as analog signals from the illuminator device 302 to the conversion device 306 and the second fiber optic cable 326 may transmit the optical feedback signals as digital signals from the optical relay 322 to the second conversion device 324.

The controller 328 may include suitable logic, circuitry, interfaces, and/or code, executable by the circuitry, that may be configured to generate the difference signal. The controller 328 may be coupled to the second conversion device 324 and may be configured to receive the electrical feedback signals from the second conversion device 324. The controller 328 may be further configured to compare the electrical feedback signals with the desired input signals to generate the difference signal. Further, the controller 328 may be configured to transmit the difference signal as a feedback to the illuminator device 302.

The illuminator device 302 may be configured to receive the difference signals as the feedback from the controller 328 and the DSP 314 may be configured to control at least one of the intensity, the phase, and the amplitude of the optical input signals generated by the optical source 312 based on the difference signal such that the optical input signals are approximately equal to the desired input signals. Thus, based on the feedback, the illuminator device 302 may adjust the generation of the optical input signal such that the input received by the plurality of satellite components 308 may be similar to the desired input signals which may operate the plurality of satellite components 308 in a desired manner.

For example, the navigation and control components that include the GPS receiver may operate at the desired input signals that may be a voltage around 3.3 volt to 5 volt. The illuminator device 302 may be configured to generate optical input signals based on the desired input signals of the GPS receiver, e.g., 3.3 volt to operate the GPS receiver. The illuminator device 302 may be further configured to transmit the generated input signals to the conversion device 306 by the way of the fiber optic cable 304. The conversion device 306 may be configured to convert the optical input signals to the electrical optical signals. During transmission it may be possible that the electrical input signals may get reduced to 3 volts due to losses. The conversion device 306 may be further configured to transmit the electrical input signals, e.g., 3 volts to the GPS receiver to operate the GPS receiver, which may not be sufficient to operate the GPS receiver.

Additionally, the conversion device 306 may be configured to transmit the electrical input signals, e.g., 3 volts to the power measuring output device 320. The power output measuring device 320 may be configured to determine the power output of the electrical input signals. Further, the optical relay 322 may be configured to convert the power output of the electrical input signals to the optical feedback signals and transmit the optical feedback signals to the second conversion device 324 by way of the second fiber optic cable 326.

The second conversion device 324 may be configured to convert the optical feedback signals to the electrical feedback signals, e.g., 3 volts and transmit the electrical feedback signals to the controller 328. The controller 328 may be configured to compare the electrical feedback signals, e.g., 3 volts with the desired input signals of the GPS receiver, e.g., 3.3 volts to generate the difference signal, e.g., 0.3 volts. The controller 328 may be further configured to transmit the difference signal, e.g., 0.3 volts to the illuminator device 302. The illuminator device 302 may be further configured to generate the optical input signals, e.g., 3.6 volts based on the difference signal (0.3 volts) that may compensate the losses and provide the electrical input signals to the plurality of components 308 such that the electrical signals are approximately equal to the desired input signals.

FIG. 3B is a block diagram illustrating the ISON system 300B, according to another aspect of the disclosed technology. The ISON system 300B may include the illuminator device 302, the fiber optic cable 304, the conversion device 306, the plurality of satellite components 308, and a feedback device 330. The illuminator device 302 may be configured to generate optical input signals based on desired input signals to operate the plurality of satellite components 308. The illuminator device 302 may be coupled to the optical fiber cable 304, and further configured to transmit the optical input signals to the conversion device 306 by way of the fiber optic cable 304.

In one embodiment, the illuminator device 302 may include the optical source 312 and the DSP 314. The optical source 312 may be configured to generate the optical input signals. The DSP 314 may include suitable logic, circuitry, interfaces, and/or code, executable by the circuitry, that may be configured to control the set of parameters of the optical input signals. The set of parameters of the optical input signals may include at least one of an intensity of the optical input signals, the phase of the optical input signals, and the amplitude of the optical input signals.

The fiber optic cable 304 may be coupled between the illuminator device 302 and the conversion device 306. The conversion device 306 may include suitable logic, circuitry, interfaces, and/or code, executable by the circuitry, that may be configured to receive the optical input signals from the illuminator device 302 via the fiber optic cable 304 and convert the optical input signals to the electrical input signals. In an embodiment, the electrical input signals are similar to the desired input signals. The conversion device 306 may be configured to transmit the electrical input signals to the plurality of satellite components 308. In one embodiment, the optical input signals are utilized for transmission between the illuminator device 302 and the plurality of satellite components 308 for faster transmission of the signal and elimination of electrical and/or magnetic interference due to transmission of signals. The conversion device 306 may be further configured to transmit the electrical input signals to the feedback device 330.

In one embodiment, the conversion device 306 includes the set of PV panels 316 and the set of directing elements 318. The set of PV panels 316 may be configured to convert the received optical input signals to the electrical input signals though the photovoltaic effect. The set of directing elements 318 may be disposed on the set of PV panels 316. Each directing element includes the mirror-coated top surface and the mirror-coated side surfaces that may be configured to receive the optical input signals and reflect the optical input signals towards the respective PV panel, thereby directing the optical input signals on the respective PV panel.

The plurality of satellite components 308 may be coupled to the conversion device 306 and may be configured to receive the electrical input signals from the conversion device 306. The plurality of satellite components 308 may be further configured to perform corresponding operations based on the electrical input signals. In one embodiment, the plurality of satellite components 308 may include the payload components, the power generation and storage components, the power management and distribution components, the thermal control components, the attitude and orbit control components, the command and data handling components, the communication components, the navigation and control components, the telemetry components, the sensor components, and the structural and mechanical components.

In another embodiment, the plurality of the satellite components may include the plurality of radiating elements that may be configured to receive the electrical input signals. Each of the plurality of radiating elements may be configured to radiate electromagnetic waves which are steered based on the DBF operations. The plurality of radiating elements may be further configured to perform beam forming operations based on the electrical input signals to implement digital beam forming.

The feedback device 330 may include a discrete circuit 332 and the controller 328. The discrete circuit 332 may include suitable logic, circuitry, interfaces, and/or code, executable by the circuitry, that may be configured to receive the electrical input signals from the conversion device 306 and generate one of pulse signals and information bits based on the electrical input signals. The discrete circuit 332 may be further configured to transmit one of the pulse signals and the information bits to the controller 328.

The controller 328 may be coupled to the discrete circuit 332 and may be configured to receive one of the pulse signals and the information bits. Further, the controller 328 may be configured to convert one of the pulse signals and the information bits to the electrical feedback signals, compare the power output of the electrical feedback signals with the power output of the desired input signals to generate the difference signal. In one embodiment, the controller 328 may be configured to transmit the difference signal as a feedback to the illuminator device 302.

The illuminator device 302 may be configured to receive the difference signals as the feedback from the controller 328 and the DSP 314 may be configured to control at least one of the intensity, the phase, and the amplitude of the optical input signals generated by the optical source 312 based on the difference signal such that the optical input signals are approximately equal to the desired input signals. Thus, based on the feedback, the illuminator device 302 may adjust the generation of the optical input signal such that the input received by the plurality of satellite components 308 may be similar to the desired input signals which may operate the plurality of satellite components 308 in a desired manner.

FIG. 3C is a block diagram illustrating the ISON system 300C, according to aspects of the disclosed technology. The ISON system 300C may include the illuminator device 302, the fiber optic cable 304, the conversion device 306, the plurality of satellite components 308, and a feedback device 334. The illuminator device 302 may be configured to generate optical input signals based on desired input signals to operate the plurality of satellite components 308. The illuminator device 302 may be coupled to the optical fiber cable 304, and further configured to transmit the optical input signals to the conversion device 306 by way of the fiber optic cable 304.

In one embodiment, the illuminator device 302 may include the optical source 312 and the DSP 314. The optical source 312 may be configured to generate the optical input signals. The DSP 314 may include suitable logic, circuitry, interfaces, and/or code, executable by the circuitry, that may be configured to control the set of parameters of the optical input signals. The set of parameters of the optical input signals may include at least one of an intensity of the optical input signals, the phase of the optical input signals, and the amplitude of the optical input signals.

The fiber optic cable 304 may be coupled between the illuminator device 302 and the conversion device 306. The conversion device 306 may include suitable logic, circuitry, interfaces, and/or code, executable by the circuitry, that may be configured to receive the optical input signals from the illuminator device 302 via the fiber optic cable 304 and convert the optical input signals to the electrical input signals. In an embodiment, the electrical input signals are similar to the desired input signals. The conversion device 306 may be configured to transmit the electrical input signals to the plurality of satellite components 308. In one embodiment, the optical input signals are utilized for transmission between the illuminator device 302 and the plurality of satellite components 308 for faster transmission of the signal and elimination of electrical and/or magnetic interference due to transmission of signals. The conversion device 306 may be further configured to transmit the electrical input signals to the feedback device 330.

In one embodiment, the conversion device 306 includes the set of PV panels 316 and the set of directing elements 318. The set of PV panels 316 may be configured to convert the received optical input signals to the electrical input signals though the photovoltaic effect. The set of directing elements 318 may be disposed on the set of PV panels 316. Each directing element includes the mirror-coated top surface and the mirror-coated side surfaces that may be configured to receive the optical input signals and reflect the optical input signals towards the respective PV panel, thereby directing the optical input signals on the respective PV panel.

The plurality of satellite components 308 may be coupled to the conversion device 306 and may be configured to receive the electrical input signals from the conversion device 306. The plurality of satellite components 308 may be further configured to perform corresponding operations based on the electrical input signals. In one embodiment, the plurality of satellite components 308 may include the payload components, the power generation and storage components, the power management and distribution components, the thermal control components, the attitude and orbit control components, the command and data handling components, the communication components, the navigation and control components, the telemetry components, the sensor components, and the structural and mechanical components.

In another embodiment, the plurality of the satellite components may include the plurality of radiating elements that may be configured to receive the electrical input signals. Each of the plurality of radiating elements may be configured to radiate electromagnetic waves which are steered based on the DBF operations. The plurality of radiating elements may be further configured to perform beam forming operations based on the electrical input signals to implement digital beam forming.

The feedback device 334 may include the power output measuring device 320, the controller 328, and a wireless communication device 336. The power output measuring device 320 may be configured to receive the electrical input signals from the conversion device 306 and determine the power output of the electrical input signals. In one embodiment, the power output measuring device 320 may be configured to determine the power output in watts. Further, the power output measuring device 320 may be configured to transmit the power output of the electrical input signals to the controller 328 by way of the wireless communication device 336. The wireless communication device 336 may be coupled between the power output measuring device 320 and the controller 328. Examples of the wireless communication device 336 may include, but are not limited to, Zigbee, Wireless Fidelity (Wi-Fi), and Bluetooth devices.

The controller 328 may be configured to receive the power output of the electrical input signals, compare the power output of the electrical input signals with the power output of the desired input signals to generate the difference signal, and transmit the difference signal as a feedback to the illuminator device 302. The illuminator device 302 may be configured to receive the difference signals as the feedback from the controller 328 and the DSP 314 may be configured to control at least one of the intensity, the phase, and the amplitude of the optical input signals generated by the optical source 312 based on the difference signal such that the optical input signals are approximately equal to the desired input signals. Thus, based on the feedback, the illuminator device 302 may adjust the generation of the optical input signal such that the input received by the plurality of satellite components 308 may be similar to the desired input signals which may operate the plurality of satellite components 308 in a desired manner.

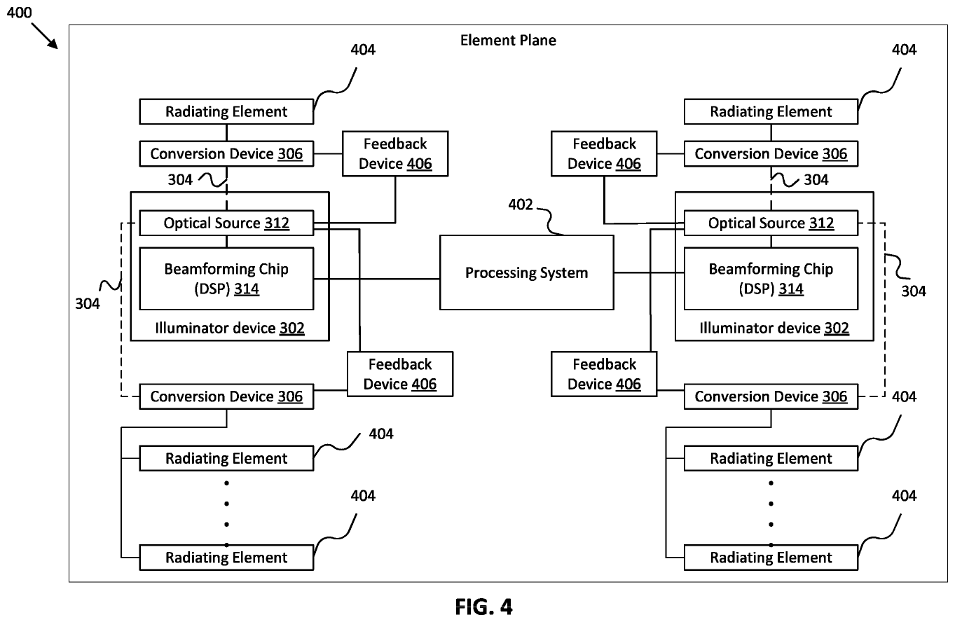

FIG. 4 is a block diagram illustrating an element plane 400 of the satellite, according to aspects of the disclosed technology. The element plane 400 of the satellite may integrate the ISON system as described in FIGS. 3A-3C. As noted above, the element plane 400 of the satellite may be a surface of the satellite where radiating elements of a phased array antenna system are formed, printed or otherwise disposed. The element plane 400 may include a processing system 402, multiple illuminator devices 302, multiple fiber optic cables 304, multiple conversion devices 306, a plurality of radiating elements 404, and multiple feedback devices 406. It will be apparent to person skilled in the art that each of the multiple illuminator devices 302, each of the multiple optical fiber cables 304, and each of the multiple conversion devices 306 may be functionally and structurally similar to the illuminator device 302, the fiber optic cable 304, and the conversion device 306, respectively, as described in FIG. 3A. It will further be apparent to person skilled in the art that each of the multiple feedback devices 406 may be functionally and structurally similar to any of the feedback device 310, 330, or 334 implemented in the ISON systems described in FIGS. 3A-3C.

Each illuminator device 302 may include the optical source 312 and the DSP 314. The optical source 312 may be configured to generate the optical input signals based on desired input signals to operate the plurality of radiating elements 404. In an embodiment, the DSP 314 may correspond to a beamforming chip and may be configured to perform one or more operations associated with the digital beam forming. Beam forming techniques may be performed in antenna systems utilizing an antenna array that includes the plurality of radiating elements 404 to create a directional antenna pattern (beam) or receiving beam from a specific direction. In satellite communications, beam forming allows satellites to dynamically adjust the beam of the satellite to cover different regions or track moving targets that improves communication reliability and efficiency. Each of the plurality of radiating elements 404 may be configured to radiate electromagnetic waves which are steered based on the DBF operations performed by the DSP 314.

The processing system 402 may include suitable logic, circuitry, interfaces, and/or code, executable by the circuitry, that may be configured to perform one or more operations associated with digital beam forming (DFB). The processing system 402 may be coupled to the DSPs 314 and configured to operate the DSPs 314 in synchronization to perform the DBF. Examples of the processing system 402 may include, but are not limited to, an application-specific integrated circuit (ASIC) processor, a reduced instruction set computing (RISC) processor, a complex instruction set computing (CISC) processor, and a field-programmable gate array (FPGA). It will be apparent to a person of ordinary skill in the art that the processing system 402 may be compatible with multiple operating systems.

The DSP 314 may be utilized in the phased array antennas. In an embodiment, the DSP 314 may be configured to control the phase and amplitude of the optical input signals generated by the set of optical sources 312 based on the desired input signals to enable precise electronic steering of beam. By adjusting the phase and the amplitude, the overall radiation pattern of the antenna may be steered.

Further, the optical source 312 may be configured to transmit the optical input signals to respective conversion devices 306 by way of respective fiber optic cables 304. Each conversion device 306 may be configured to convert the optical input signals to the electrical input signals and transmit the electrical input signals to the plurality of radiating elements 404. In an embodiment, each conversion device of the multiple conversion devices 306 may be coupled to multiple radiating elements of the plurality of radiating elements 404. In another embodiment, each conversion device of the set of conversion devices 306 may be coupled to a respective radiating element of the plurality of radiating elements 404.

A radiating element is an important component in the design and function of an antenna. The radiating element may be configured to transmit or receive electromagnetic energy in a frequency band (e.g., a microwave frequency band). The radiating elements 404 may be configured to receive the electrical input signals from respective conversion devices 306 and perform beam forming operations based on the electrical input signals to implement the DBF. In an embodiment, the antenna system of the satellite may include the antenna array including any number of radiating elements such as the radiating elements 404 collectively configured as part of phased array antenna system that may be capable of both transmitting and receiving signals. The arrangement and design of the plurality of radiating elements 404 may determine radiation pattern of the antenna.

In an embodiment, each feedback device of the multiple feedback devices 406 maybe coupled between respective conversion device 306 and respective illuminator device 302. Each conversion device 306 may be further configured to transmit the electrical input signals to the respective feedback device. In one embodiment, the feedback device 406 may be implemented in a manner structurally and functionally similar to the feedback device 308 described in FIG. 3A. The feedback device 406 may be configured to determine the power output of the electrical input signals and generate a difference signal based on the electrical input signals and the desired input signals. The difference may indicate variations between the desired input signals and the electrical input signals. Further, the feedback device 406 may be configured to transmit the difference signal to the respective illuminator device 302. The set of optical sources 312 may be further configured to generate the optical input signals based on the difference signals to operate the plurality of radiating elements 404. Additionally, the set of DSPs may be configured to control the phase and amplitude of the optical input signals generated by the set of optical sources 312 based on the difference signals to enable precise electronic steering of beam.

### Examples of Systems for Intra-Satellite Optical Networking (ISON)

### First Embodiment

In one non-limiting embodiment of the present disclosure, a system for ISON is provided that includes an element plane of a satellite including a plurality of radiating elements, a conversion device, an illuminator device that is coupled to the conversion device by a fiber optic cable and a feedback device coupled between the conversion device and the illuminator device. In one embodiment, the element plane of the satellite may include or be a surface of the satellite where radiating elements of a phased array antenna system are formed, printed or otherwise disposed. The illuminator device may comprise an optical source configured to generate optical input signals based on desired input signals for operating at least one of the plurality of radiating elements. The system may also include a DSP coupled to the optical source. The DSP may be configured to control one or more parameters of the optical input signals including at least one of an intensity, a phase, and an amplitude of the optical input signals.

The conversion device can include a set of photovoltaic (PV) panels configured to convert the optical input signals into electrical input signals, and a set of directing elements disposed on the set of PV panels, each directing element including a mirror-coated top surface and mirror-coated side surfaces configured to receive the optical input signals and reflect the optical input signals toward a respective PV panel of the set of PV panels.

The feedback device may comprise a power output measuring device, an optical relay coupled to the power output measuring device, a second fiber optic cable coupled to the optical relay, a second conversion device coupled to the second fiber optic cable, and a controller coupled to the second conversion device. The power output measuring device may be configured to determine a power output of the electrical input signals. The optical relay may be configured to convert the power output of the electrical input signals into optical feedback signals. The second conversion device may be configured to convert the optical feedback signals into electrical feedback signals. The controller can compare the electrical feedback signals with the desired input signals to generate a difference signal and transmit the difference signal to the illuminator device. The DSP may be configured to control the optical source based on the difference signal such that the electrical input signals are adjusted toward the desired input signals.

The system may also include one or more of the following features. In some embodiments, each conversion device may be coupled to a single radiating element of the plurality of radiating elements, whereas in other embodiments, each conversion device may be coupled to multiple radiating elements of the plurality of radiating elements. In some embodiments, the fiber optic cable may be configured to transmit the optical input signals utilizing a time domain switching technique. In some embodiments, the fiber optic cable may be configured to transmit the optical input signals utilizing a frequency domain switching technique.

In some embodiments, the system may include a plurality of DSPs of a plurality of illuminator devices and a processor configured to synchronize the plurality of DSPs to perform digital beam forming. The optical source may be configured to generate the optical input signals based on difference signals indicative of variations between the desired input signals and the electrical input signals. The optical relay may comprise, for example, one of a light emitting diode and a laser diode. Depending on the implementation, the optical relay may be configured as one of a digital optical relay and an analog optical relay. Depending on the implementation, the fiber optic cable may comprise a single-mode fiber and the second fiber optic cable may comprise a multimode fiber

### Second Non-Limiting Embodiment

In another non-limiting embodiment of the present disclosure, a system for ISON is provided that includes an element plane of a satellite, a plurality of illuminator devices, a plurality of fiber optic cables, a plurality of conversion devices, and a processing system. The element plane includes a substrate having a plurality of radiating elements of a phased array antenna system formed on the substrate. In one embodiment, the element plane of the satellite may be or include a surface of the satellite where the radiating elements of the phased array antenna system are formed, printed or otherwise disposed. Each fiber optic cable couples a respective illuminator device to a respective conversion device.

Each illuminator device comprises an optical source configured to generate optical input signals based on desired input signals for operating at least one radiating element, and a digital signal processor (DSP) coupled to the optical source and configured to control phase and amplitude of the optical input signals to perform digital beam forming (DBF). Each conversion device may be configured to receive the optical input signals, convert the optical input signals into electrical input signals, and transmit the electrical input signals to at least one radiating element. The processing system may be configured to synchronize the DSPs of the plurality of illuminator devices to perform digital beam forming across the plurality of radiating elements.

In some embodiments, each conversion device may comprise a set of photovoltaic panels and a set of directing elements disposed on the set of photovoltaic panels. In one embodiment, each conversion device may be coupled to a single radiating element.

Each DSP may be configured to dynamically adjust the phase and amplitude of the optical input signals to enable electronic beam steering.

The optical source of each illuminator device may be configured to generate the optical input signals based on difference signals indicative of variations between the desired input signals and the electrical input signals.

In some embodiments, the system may further comprise a plurality of feedback devices. Each feedback device may be coupled between a respective conversion device and a respective illuminator device. Each feedback device may be configured to determine a power output of the electrical input signals, generate a difference signal based on the electrical input signals and the desired input signals, and transmit the difference signal to the respective illuminator device. In some implementations, each radiating element may be configured to operate in a microwave frequency band.

### Exemplary Conversion Device

In one non-limiting embodiment of the present disclosure, a conversion device is provided for use in an intra-satellite optical networking system (ISON). The exemplary conversion device may include a set of photovoltaic (PV) panels configured to convert received optical input signals into electrical input signals. The exemplary conversion device may also include a set of directing elements disposed on the set of PV panels. In one implementation, each directing element can include a mirror-coated top surface and mirror-coated side surfaces. Each directing element may be configured to receive optical input signals from a fiber optic cable termination and reflect the optical input signals toward a respective region of a PV panel. The conversion device may also include an electrical interface that provides the electrical input signals to at least one radiating element or satellite component.

Depending on the implementation, the conversion device may include one or more of the following features. For instance, in some implementations, the conversion device may be disposed on an element plane of a satellite (e.g., a structure or surface of the satellite where radiating elements of a phased array antenna system are formed, printed or otherwise disposed). The conversion device may be coupled to at least one radiating element and configured to provide the electrical input signals to a power output measuring device for closed-loop feedback control. The directing elements may be configured to receive optical input signals from one of a multimode fiber and a single-mode fiber. The conversion device may be configured to convert the optical input signals into electrical input signals providing a nominal voltage in a range of approximately 3.3 volts to 5 volts.

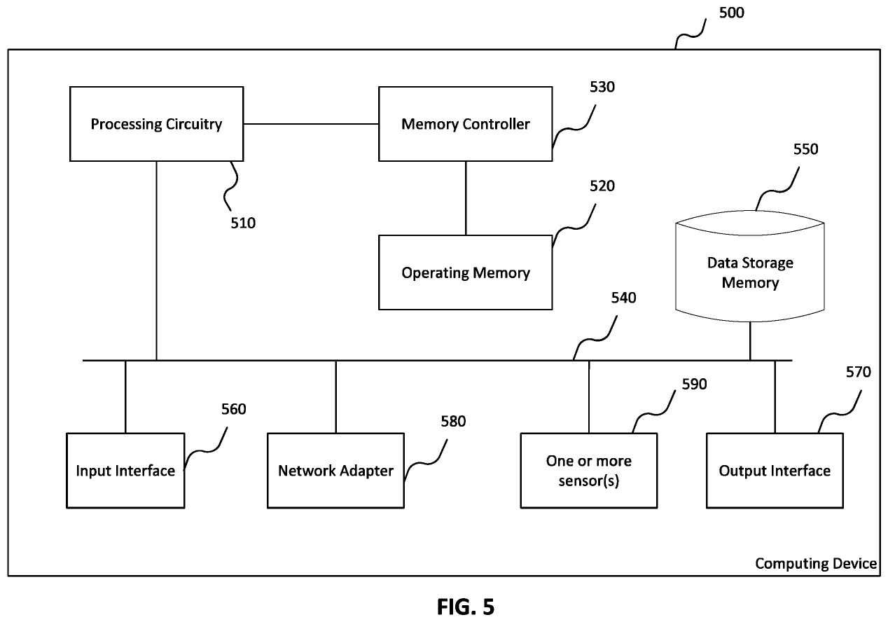

FIG. 5 is a diagram illustrating one example of computing device 500 in which aspects of the technology may be practiced. Computing device 500 may be virtually any type of general-purpose or specific-purpose computing device. For example, computing device 500 may be an example of the controller 220 or a processor of the satellite 120, a computing system or device associated with any entity (e.g., UE 110, satellite 120) as described above with reference to FIGS. 1-5.

As illustrated in FIG. 5, computing device 500 includes processing circuit 510, operating memory 520, memory controller 530, data storage memory 550, input interface 560, output interface 570, one or more network adapter(s) 580, and in some embodiments, one or more sensor(s) 590. Each of these afore-listed components of computing device 500 includes at least one hardware element.

Computing device 500 includes at least one processing circuit 510 configured to execute instructions, such as instructions for implementing the herein-described workloads, processes, or technology. Processing circuit 510 may include a microprocessor, a microcontroller, a graphics processor, a coprocessor, a field-programmable gate array, a programmable logic device, a signal processor, or any other circuit suitable for processing data. The aforementioned instructions, along with other data (e.g., datasets, metadata, operating system instructions, etc.), may be stored in operating memory 520 during run-time of computing device 500. Operating memory 520 may also include any of a variety of data storage devices/components, such as volatile memories, semi-volatile memories, random access memories, static memories, caches, buffers, or other media used to store run-time information. In one example, operating memory 520 does not retain information when computing device 500 is powered off. Rather, computing device 500 may be configured to transfer instructions from a non-volatile data storage component (e.g., data storage memory 550) to operating memory 520 as part of a booting or other loading process. In some examples, other forms of execution may be employed, such as execution directly from data storage memory 550.

Operating memory 520 may include 4th generation double data rate (DDR 4) memory, 3rd generation double data rate (DDR 3) memory, other dynamic random access memory (DRAM), High Bandwidth Memory (HBM), Hybrid Memory Cube memory, 3D-staked memory, static random access memory (SRAM), magneto resistive random access memory (MRAM), pseudorandom random access memory (PSRAM), or other memory, and such memory may comprise one or more memory circuits integrated onto a DIMM, SIMM, SODIMM, Known Good Die (KGD), or other packaging. Such operating memory modules or devices may be organized according to channels, ranks, and banks. For example, operating memory devices may be coupled to processing circuit 510 via memory controller 530 in channels. One example of computing device 500 may include one or two DIMMs per channel, with one or two ranks per channel. Operating memory within a rank may operate with a shared clock, and shared address and command bus. Also, an operating memory device may be organized into several banks where a bank may be thought of as an array addressed by row and column. Based on such an organization of operating memory, physical addresses within the operating memory may be referred to by a tuple of channel, rank, bank, row, and column.

Despite the above discussion, operating memory 520 specifically does not include or encompass communications media, any communications medium, or any signals per se.

Memory controller 530 is configured to interface processing circuit 510 to operating memory 520. For example, memory controller 530 may be configured to interface commands, addresses, and data between operating memory 520 and processing circuit 510. Memory controller 530 may also be configured to abstract or otherwise manage certain aspects of memory management from or for processing circuit 510. Although memory controller 530 is illustrated as single memory controller separate from processing circuit 510, in other examples, multiple memory controllers may be employed, memory controller(s) may be integrated with operating memory 520, or the like. Further, memory controller(s) may be integrated into processing circuit 510. These and other variations are possible.

In computing device 500, data storage memory 550, input interface 560, output interface 570, network adapters 580, and sensors 590 may be interfaced to processing circuit 510 by bus 540. Although, FIG. 5 illustrates bus 540 as a single passive bus, other configurations, such as a collection of buses, a collection of point-to-point links, an input/output controller, a bridge, other interface circuitry, or any collection thereof may also be suitably employed for interfacing data storage memory 550, input interface 560, output interface 570, or network adapters 580 to processing circuit 510.

In computing device 500, data storage memory 550 is employed for long-term non-volatile data storage. Data storage memory 550 may include any of a variety of non-volatile data storage devices/components, such as non-volatile memories, disks, disk drives, hard drives, solid-state drives, or any other media that can be used for the non-volatile storage of information. However, data storage memory 550 specifically does not include or encompass communications media, any communications medium, or any signals per se. In contrast to operating memory 520, data storage memory 550 is employed by computing device 500 for non-volatile long-term data storage, instead of for run-time data storage.

Also, computing device 500 may include or be coupled to any type of processor-readable media such as processor-readable storage media (e.g., operating memory 520 and data storage memory 550) and communication media (e.g., communication signals and radio waves). While the term processor-readable storage media includes operating memory 520 and data storage memory 550, the term “processor-readable storage media,” throughout the specification and the claims whether used in the singular or the plural, is defined herein so that the term “processor-readable storage media” specifically excludes and does not encompass communications media, any communications medium, or any signals per se. However, the term “processor-readable storage media” does encompass processor cache, Random Access Memory (RAM), register memory, and/or the like.

Computing device 500 also includes input interface 560, which may be configured to enable computing device 500 to receive input from users or from other devices, such as sensors 590, in some embodiments. In addition, computing device 500 includes output interface 570, which may be configured to provide output from computing device 500.

In the illustrated example, computing device 500 is configured to communicate with other computing devices or entities via network adapters 580. Network adapters 580 may include a wired network adapter, e.g., an Ethernet adapter, a Token Ring adapter, or a Digital Subscriber Line (DSL) adapter. Network adapters 580 may also include a wireless network adapter, for example, a Wi-Fi adapter, a Bluetooth adapter, a ZigBee adapter, a Long-Term Evolution (LTE) adapter, SigFox, LoRa, Powerline, or a 5G adapter.

Although computing device 500 is illustrated with certain components configured in a particular arrangement, these components and arrangement are merely one example of a computing device in which the technology may be employed. In other examples, data storage memory 550, input interface 560, output interface 570, or network adapters 580 may be directly coupled to processing circuit 510, or be coupled to processing circuit 510 via an input/output controller, a bridge, or other interface circuitry. Other variations of the technology are possible.

Some examples of computing device 500 include at least one memory (e.g., operating memory 520) adapted to store run-time data and at least one processor (e.g., processing circuit 510) that is adapted to execute processor-executable code that, in response to execution, enables computing device 500 to perform actions, where the actions may include, in some examples, actions for one or more methodologies or processes described herein.

In some embodiments, when the device or system include one or more sensors 590, the sensors may be configured to sense or gather data pertaining to the surrounding environment or operation of the device or system. Some exemplary sensors capable of being electronically coupled with the device or system of the present disclosure (either directly connected to the device or system of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; Global Positioning sensors sensing location, elevation, distance traveled, velocity/speed; audio sensors sensing local environmental sound levels, or voice detection; photo/Light sensors sensing ambient light intensity, ambient, day/night, UV exposure; TV/IR sensors sensing light wavelength; temperature sensors sensing machine or motor temperature, ambient air temperature, and environmental temperature; and moisture sensors for sensing surrounding moisture levels.

The device or system of the present disclosure may include wireless communication logic coupled to sensors on the device or system. The sensors gather data and provide the data to the wireless communication logic. Then, the wireless communication logic may transmit the data gathered from the sensors to a remote device. Thus, the wireless communication logic may be part of a broader communication system, in which one or several devices or systems of the present disclosure may be networked together to report alerts and, more generally, to be accessed and controlled remotely. Depending on the types of transceivers installed in the device or system of the present disclosure, the system may use a variety of protocols (e.g., Wifi, ZigBee, MiWi, Bluetooth) for communication. In one example, each of the devices or systems of the present disclosure may have its own IP address and may communicate directly with a router or gateway. This would typically be the case if the communication protocol is WiFi.

In another example, a point-to-point communication protocol like MiWi or ZigBee is used. One or more of the device or system of the present disclosure may serve as a repeater, or the devices or systems of the present disclosure may be connected together in a mesh network to relay signals from one device or system to the next. However, the individual device or system in this scheme typically would not have IP addresses of their own. Instead, one or more of the devices or system of the present disclosure communicates with a repeater that does have an IP address, or another type of address, identifier, or credential that may be needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system also allows individuals to access the device or system of the present disclosure for configuration and diagnostic purposes. In that case, the individual processors or microcontrollers of the device or system of the present disclosure may be configured to act as Web servers that use a protocol like hypertext transfer protocol (HTTP) to provide an online interface that can be used to configure the device or system. In some embodiments, the systems may be used to configure several devices or systems of the present disclosure at once. For example, if several devices or systems are of the same model and are in similar locations in the same location, it may not be to configure the devices or systems individually. Instead, an individual may provide configuration information, including baseline operational parameters, for several devices or systems at once.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Definitions, as defined and used herein, should be understood to control over dictionary definitions, definitions in documents incorporated by reference, and/or ordinary meanings of the defined terms. “Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software-controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (e.g., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an example embodiment,” “an exemplary embodiment,” or “other embodiments,” or the like, means that a particular feature, structure, or characteristic described in connection with the embodiments is included in at least some embodiments, but not necessarily all embodiments, of the disclosure. The various appearances “an embodiment,” “one embodiment,” “some embodiments,” “one particular embodiment,” “an example embodiment,” “an exemplary embodiment,” or “other embodiments,” or the like, are not necessarily all referring to the same embodiments. References in the specification to “an embodiment,” “one embodiment,” “some embodiments,” “one particular embodiment,” “an example embodiment,” “an exemplary embodiment,” or “other embodiments,” or the like, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. As used herein in the specification and claims, including as used in the examples and unless otherwise expressly specified, numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, transitional phrases such as “comprising,” “including,” “carrying,” “having,” “containing,” “involving,” “holding,” “composed of,” and the like are to be understood to be open-ended, e.g., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

The description and illustration of various embodiments of the disclosure are examples and the disclosure is not limited to the exact details shown or described. While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

What is claimed:

1. A system for intra-satellite optical networking (ISON), the system comprising:
an element plane of a satellite, the element plane comprising: a plurality of radiating elements of a phased array antenna system formed thereon;
an illuminator device comprising:
an optical source configured to generate optical input signals based on desired input signals for operating at least one of the plurality of radiating elements; and
a digital signal processor (DSP) coupled to the optical source and configured to control at least one parameter of the optical input signals including at least one of an intensity, a phase, and an amplitude of the optical input signals;
a conversion device;
a fiber optic cable coupling the illuminator device to the conversion device;
the conversion device comprising:
a set of photovoltaic (PV) panels configured to convert the optical input signals into electrical input signals; and
a set of directing elements disposed on the set of PV panels, each directing element including a mirror-coated top surface and mirror-coated side surfaces configured to receive the optical input signals and reflect the optical input signals toward a respective PV panel of the set of PV panels; and
a feedback device coupled between the conversion device and the illuminator device, the feedback device comprising:
a power output measuring device configured to determine a power output of the electrical input signals;
an optical relay coupled to the power output measuring device and configured to convert the power output of the electrical input signals into optical feedback signals;
a second fiber optic cable coupled to the optical relay;
a second conversion device coupled to the second fiber optic cable and configured to convert the optical feedback signals into electrical feedback signals; and
a controller coupled to the second conversion device and configured to compare the electrical feedback signals with the desired input signals to generate a difference signal and transmit the difference signal to the illuminator device,
wherein the DSP is configured to control the optical source based on the difference signal such that the electrical input signals are adjusted toward the desired input signals.

2. The system of claim 1, wherein each conversion device is coupled to a single radiating element of the plurality of radiating elements.

3. The system of claim 1, wherein each conversion device is coupled to multiple radiating elements of the plurality of radiating elements.

4. The system of claim 1, wherein the fiber optic cable is configured to transmit the optical input signals utilizing a time domain switching technique.

5. The system of claim 1, wherein the fiber optic cable is configured to transmit the optical input signals utilizing a frequency domain switching technique.

6. The system of claim 1, further comprising:
a processor configured to synchronize a plurality of DSPs of a plurality of illuminator devices to perform digital beam forming.

7. The system of claim 1, wherein the optical source is configured to generate the optical input signals based on difference signals indicative of variations between the desired input signals and the electrical input signals.

8. The system of claim 1, wherein the optical relay comprises one of a light emitting diode and a laser diode.

9. The system of claim 1, wherein the optical relay is configured as one of a digital optical relay and an analog optical relay.

10. The system of claim 1, wherein the fiber optic cable comprises:
a single-mode fiber and the second fiber optic cable comprises a multimode fiber.

11. A system for intra-satellite optical networking (ISON), the system comprising:
an element plane comprising a substrate and a plurality of radiating elements formed on the substrate, wherein the plurality of radiating elements are part of a phased array antenna system;
a plurality of illuminator devices, each illuminator device comprising:
an optical source configured to generate optical input signals based on desired input signals for operating at least one radiating element; and
a digital signal processor (DSP) coupled to the optical source and configured to control phase and amplitude of the optical input signals to perform digital beam forming (DBF);
a plurality of fiber optic cables, each fiber optic cable coupling a respective illuminator device to a respective conversion device;
a plurality of conversion devices, each conversion device being configured to:
receive the optical input signals,
convert the optical input signals into electrical input signals, and
transmit the electrical input signals to at least one radiating element; and
a processing system configured to synchronize the DSPs of the plurality of illuminator devices to perform digital beam forming across the plurality of radiating elements.

12. The system of claim 11, wherein each conversion device comprises:
a set of photovoltaic panels; and
a set of directing elements disposed on the set of photovoltaic panels.

13. The system of claim 11, wherein each conversion device is coupled to a single radiating element.

14. The system of claim 11, wherein each DSP is configured to dynamically adjust the phase and amplitude of the optical input signals to enable electronic beam steering.

15. The system of claim 11, wherein the optical source of each illuminator device is configured to generate the optical input signals based on difference signals indicative of variations between the desired input signals and the electrical input signals.

16. The system of claim 15, further comprising:
a plurality of feedback devices, each feedback device being coupled between a respective conversion device and a respective illuminator device and configured to:
determine a power output of the electrical input signals;
generate a difference signal based on the electrical input signals and the desired input signals; and
transmit the difference signal to the respective illuminator device.

17. The system of claim 11, wherein each radiating element is configured to operate in a microwave frequency band.

18. A conversion device for use in an intra-satellite optical networking system, the conversion device comprising:
a set of photovoltaic (PV) panels configured to convert received optical input signals into electrical input signals;
a set of directing elements disposed on the set of PV panels, each directing element including a mirror-coated top surface and mirror-coated side surfaces configured to receive optical input signals from a fiber optic cable termination and reflect the optical input signals toward a respective region of a PV panel; and
an electrical interface configured to provide the electrical input signals to at least one radiating element or satellite component.

19. The conversion device of claim 18, wherein the conversion device is disposed on an element plane of a satellite and is coupled to at least one radiating element.

20. The conversion device of claim 18, wherein the conversion device is configured to provide the electrical input signals to a power output measuring device for closed-loop feedback control.

21. The conversion device of claim 18, wherein the directing elements are configured to receive optical input signals from one of a multimode fiber and a single-mode fiber.

22. The conversion device of claim 18, wherein the conversion device is configured to convert the optical input signals into electrical input signals providing a nominal voltage in a range of approximately 3.3 volts to 5 volts.

23. A system for Intra-Satellite Optical Networking (ISON), the system comprising:
a plurality of satellite components;
an illuminator device configured to generate optical input signals based on desired input signals to operate the plurality of satellite components;
a conversion device configured to convert the optical input signals to electrical input signals; and
a fiber optic cable coupled between the illuminator device and the conversion device, wherein the illuminator device is further configured to transmit the optical input signals to the conversion device by way of the fiber optic cable, and wherein the plurality of satellite components are coupled to the conversion device, and configured to receive the electrical input signals and perform corresponding operations based on the electrical input signals.

24. The system of claim 23, wherein the illuminator device comprises:
an optical source configured to generate the optical input signals; and
a processor coupled to the optical source, and configured to control a set of parameters of the optical input signals generated by the optical source based on the desired input signals, wherein the set of parameters of the optical input signals comprises at least one of an intensity of the optical input signals, a phase of the optical input signals, and an amplitude of the optical input signals.

25. The system of claim 23, wherein the conversion device comprises:
a set of photovoltaic (PV) panels configured to convert the optical input signals to the electrical input signals; and
a set of directing elements disposed on the set of PV panels, wherein each directing element of the set of directing elements is configured to direct the optical input signals received through the fiber optic cable on respective PV panel of the set of PV panels.

26. The system of claim 25, wherein each directing element of the set of directing element comprises a mirror-coated top surface and mirror-coated side surfaces configured to receive the optical input signals and reflect the optical input signals towards the respective PV panel, thereby directing the optical input signals on the respective PV panel.

27. The system of claim 23, further comprising:
a feedback device configured to determine a power output of the electrical input signals and generate a difference signal based on the electrical input signals and the desired input signals, wherein the illuminator device generates the optical input signals further based on the difference signal.

28. The system of claim 27, wherein the feedback device comprises:
a power output measuring device configured to determine the power output of the electrical input signals;
an optical relay coupled to the power output measuring device, and configured to convert the power output of the electrical input signals to optical feedback signals;
a second conversion device configured to receive the optical feedback signals and convert the optical feedback signals to electrical feedback signals;
a second fiber optic cable coupled between the optical relay and the second conversion device, wherein the optical relay is further configured to transmit the optical feedback signals to the second conversion device by way of the second fiber optic cable; and
a controller coupled to the second conversion device, and configured to compare the electrical feedback signals with the desired input signals to generate the difference signal and transmit the difference signal as a feedback to the illuminator device.

29. The system of claim 27, wherein the feedback device comprises:
a discrete circuit configured to receive the electrical input signals, generate one of pulse signals and information bits based on the electrical input signals, and transmit one of the pulse signals and the information bits; and
a controller coupled to the discrete circuit, and configured to receive one of the pulse signals and the information bits, convert one of the pulse signals and the information bits to electrical feedback signals, compare a power output of the electrical feedback signals with a power output of the desired input signals to generate the difference signal, and transmit the difference signal as a feedback to the illuminator device.

30. The system of claim 27, wherein the feedback device comprises:
a power output measuring device configured to determine the power output of the electrical input signals;
a controller configured to receive the power output of the electrical input signals, compare the power output of the electrical input signals with a power output of the desired input signals to generate the difference signal, and transmit the difference signal as feedback to the illuminator device; and
a wireless communication device coupled between the power output measuring device and the controller, wherein the power output measuring device is further configured to transmit the power output of the electrical input signals to the controller by way of the wireless communication device.

31. The system of claim 23, wherein the plurality of the satellite components comprise payload components, power generation and storage components, power management and distribution components, thermal control components, attitude and orbit control components, command and data handling components, communication components, navigation and control components, telemetry components, sensor components, and structural and mechanical components.

32. The system of claim 23, wherein the plurality of the satellite components comprise:
a plurality of radiating elements of a phased array antenna system each being configured to receive the electrical input signals and perform beam forming operations based on the electrical input signals to implement digital beam forming, wherein the plurality of radiating elements are formed on the element plane.

33. The system of claim 23, wherein the fiber optic cable is further configured to transmit the optical input signals from the illuminator device to the conversion device utilizing one of a time domain switching technique and a frequency domain switching technique.

34. A system for intra-satellite optical networking (ISON), the system comprising:
an element plane comprising a plurality of radiating elements of a phased array antenna formed on a substrate;
a processor;
a plurality of illuminator devices, each including: an optical source configured to generate optical input signals based on desired input signals for operating a plurality of radiating elements; and a digital signal processor (DSP) configured to perform digital beam forming (DBF) operations by controlling the phase and amplitude of the optical input signals;
a plurality of fiber optic cables, each configured to transmit the optical input signals from a respective illuminator device; and
a plurality of conversion devices, each configured to receive and convert the optical input signals into electrical input signals,
wherein each of the plurality of radiating elements are coupled to at least one of the plurality of conversion devices, wherein each of the plurality of conversion devices is configured to transmit the electrical input signals to at least one of the respective radiating elements, and wherein the plurality of radiating elements are each configured to receive the electrical input signals from the at least one of the plurality of conversion devices coupled to respective radiating element.

35. The system of claim 12, wherein each of the plurality of radiating elements is configured to radiate electromagnetic waves steered based on the DBF operations performed by the DSP.

36. The system of claim 12, wherein the processor is configured to synchronize the DSPs of the plurality of illuminator devices to perform digital beam forming.

37. The system of claim 12, wherein the optical source of each illuminator device is configured to generate optical input signals based on difference signals that indicate variations between the desired input signals and the electrical input signals.

38. The system of claim 15, further comprising a plurality of feedback devices, each coupled between a respective conversion device and a respective illuminator device, wherein each of the plurality of feedback devices is configured to:
determine the power output of the electrical input signals;
generate a difference signal based on the electrical input signals and the desired input signals; and
transmit the difference signal to the respective illuminator device.

39. The system of claim 12, wherein each DSP is configured to dynamically adjust the phase and amplitude of the optical input signals to enable electronic beam steering.

40. The system of claim 12, wherein the plurality of radiating elements collectively form a phased array antenna system.

41. The system of claim 12, wherein each conversion device is coupled to a single radiating element of the plurality of radiating elements.

42. The system of claim 12, wherein each conversion device is coupled to multiple radiating elements of the plurality of radiating elements.

43. The system of claim 12, wherein each radiating element is configured to operate in a microwave frequency band.
